(19) United States
(12) Patent Application Publication
(10) Pub. No.: US 2022/0399022 A1
(43) Pub. Date: Dec. 15, 2022

(54) ELECTRONIC DEVICE AND METHOD FOR OPERATING THEREOF

(71) Applicant: SAMSUNG ELECTRONICS CO., LTD., Suwon-si (KR)

(72) Inventors: Junho LEE, Suwon-si (KR); Youngsub KO, Suwon-si (KR); Joohwan KIM, Suwon-si (KR); Kisub SONG, Suwon-si (KR); Jaechul LEE, Suwon-si (KR); Youngjin JEON, Suwon-si (KR)

(21) Appl. No.: 17/836,224

(22) Filed: Jun. 9, 2022

Related U.S. Application Data
(63) Continuation of application No. PCT/KR2022/007756, filed on May 31, 2022.

(30) Foreign Application Priority Data
Jun. 9, 2021 (KR) 10-2021-0074859

(51) Int. Cl. G10L 15/22; G10L 15/30; G10L 17/22

(52) U.S. Cl. CPC G10L 15/22; G10L 15/30; G10L 17/22

(57) ABSTRACT

Examples described herein provide an electronic device, which may include a communication circuit, a memory, and a processor operatively connected to the communication circuit and the memory. The memory may store instructions that, when executed, cause the processor to receive a voice input of a user from an external electronic device by using the communication circuit, to recognize voice metadata associated with the voice input based on the voice input, to determine, based on the voice metadata, whether there is a precondition to perform an action corresponding to the voice input, responsive to determining that the precondition is present, to transmit a first command for performing an action corresponding to the precondition based on the voice metadata to a target device by using the communication circuit, and to transmit a second command for performing the action corresponding to the voice input to the target device by using the communication circuit.

### TECHNICAL FIELD

Various embodiments disclosed in this specification are related to a technology for processing a user's voice input.

### BACKGROUND ART

With the development of a speech recognition technology, a speech recognition function may be implemented in various electronic devices including microphones. For example, a voice assistant service capable of controlling an operation between a plurality of electronic devices through speech recognition has been recently developed. For example, the voice assistant service may organically transmit and receive information between a plurality of electronic devices through speech recognition, and may perform an action corresponding to an utterance. For example, a user may control an operation of a desired Internet of Things (IoT) device by entering a voice input (e.g., a voice command) to a mobile device.

### DISCLOSURE

### Technical Problem

Various embodiments of the disclosure provide an electronic device capable of determining whether there is a precondition to perform an action corresponding to a user's voice input, and performing an action corresponding to the precondition before performing the action corresponding to the voice input when the precondition is present, and an operating method of the electronic device.

### Technical Solution

According to an embodiment disclosed in this specification, an electronic device may include a communication circuit, a memory, and a processor operatively connected to the communication circuit and the memory. The memory may store instructions that, when executed, cause the processor to receive a voice input of a user from an external electronic device by using the communication circuit, to recognize voice metadata associated with the voice input based on the voice input, to determine, based on the voice metadata, whether there is a precondition to perform an action corresponding to the voice input, responsive to determining that the precondition is present, to transmit a first command for performing an action corresponding to the precondition based on the voice metadata to a target device by using the communication circuit, and to transmit a second command for performing the action corresponding to the voice input to the target device by using the communication circuit.

Furthermore, according to an embodiment of the disclosure, an operating method of an electronic device may include receiving a voice input of a user from an external electronic device, recognizing voice metadata associated with the voice input based on the voice input, determining, based on the voice metadata, whether there is a precondition to perform an action corresponding to the voice input, responsive to determining that the precondition is present, transmitting a first command for performing an action corresponding to the precondition, based on the voice metadata to a target device, and transmitting a second command for performing the action corresponding to the voice input to the target device.

Moreover, according to an embodiment of the disclosure, in a computer-readable recording medium storing instructions, the instructions, when executed by an electronic device, cause the electronic device to perform receiving a voice input of a user from an external electronic device, recognizing voice metadata associated with the voice input based on the voice input, determining, based on the voice metadata, whether there is a precondition to perform an action corresponding to the voice input, responsive to determining that the precondition is present, transmitting a first command for performing an action corresponding to the precondition, based on the voice metadata to a target device, and transmitting a second command for performing the action corresponding to the voice input to the target device.

According to another embodiment of the disclosure, an operating method of an electronic device may include recognizing voice metadata associated with a voice input of the user based on a voice input received from an external electronic device, determining, based on the voice metadata and a state of a target device, whether a precondition to perform an action corresponding to the voice input is present, responsive to determining that the precondition is present, transmitting a first command for performing an action corresponding to the precondition based on the voice metadata to the target device, and transmitting a second command for performing the action corresponding to the voice input to the target device.

### Advantageous Effects

According to the embodiments described in this specification, it may be determined whether there is a precondition for performing an action according to a user's voice input.

According to the embodiments described in this specification, responsive to there being a precondition present for performing an action according to a voice input, an action corresponding to the precondition may be automatically performed.

According to the embodiments described in this specification, it is possible to perform a series of operations of determining the user's intent and controlling or providing a function of a target device that matches the user's intent.

Besides, a variety of effects directly or indirectly understood through the specification may be provided.

### DESCRIPTION OF DRAWINGS

FIG. 1 is a block diagram illustrating an electronic device in a network environment according to various embodiments;

FIG. 2 is a block diagram illustrating an integrated intelligence system, according to an embodiment.

FIG. 3 is a diagram illustrating the form in which relationship information between a concept and an action is stored in a database, according to an embodiment.

FIG. 4 is a view illustrating a user terminal displaying a screen of processing a voice input received through an intelligence app, according to an embodiment.

FIG. 5 is a block diagram of an electronic device, according to an embodiment.

FIG. 6 is a diagram illustrating an artificial intelligence assistant system, according to an embodiment.

FIG. 7 is a diagram for describing an operation of an intent handler module, according to an embodiment.

FIG. 8 is a diagram for describing an operation of an intent handler module, according to an embodiment.

FIG. 9 is a flowchart illustrating an operation of an artificial intelligence assistant system, according to an embodiment.

FIG. 10 is a flowchart illustrating an operation of registering voice metadata in a voice metadata server, according to an embodiment.

FIG. 11 is a flowchart of a method of operating an electronic device, according to an embodiment.

FIG. 12 is a flowchart of an operating method of an electronic device, according to an embodiment.

FIGS. 13A to 13G are examples of a user interface for generating voice metadata, according to an embodiment.

With regard to description of drawings, the same or similar components will be marked by the same or similar reference signs.

### MODE FOR INVENTION

One or more embodiments of the invention now will be described more fully hereinafter with reference to the accompanying drawings, in which various embodiments are shown. One or more embodiments may, however, be embodied in many different forms, and should not be construed as limited to the embodiments set forth herein. Rather, these embodiments are provided so that this disclosure will be thorough and complete, and will fully convey the scope of embodiments of the invention to those skilled in the art.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

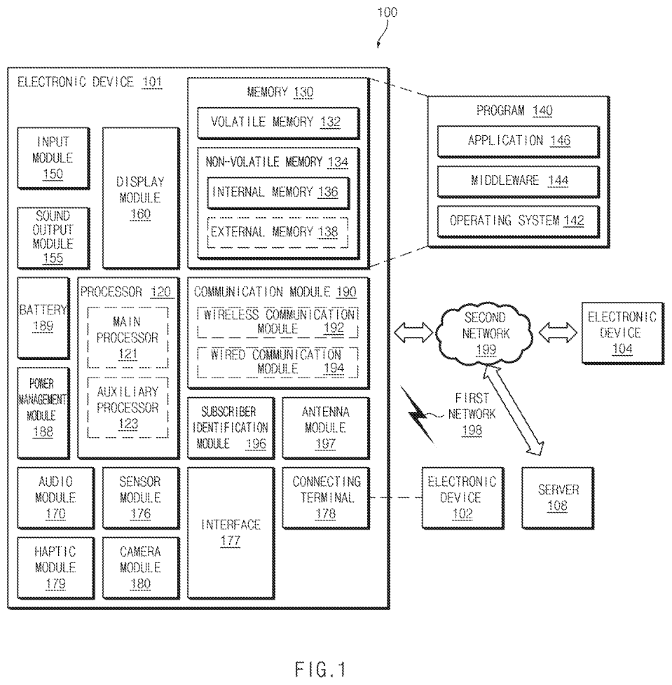

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form an mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

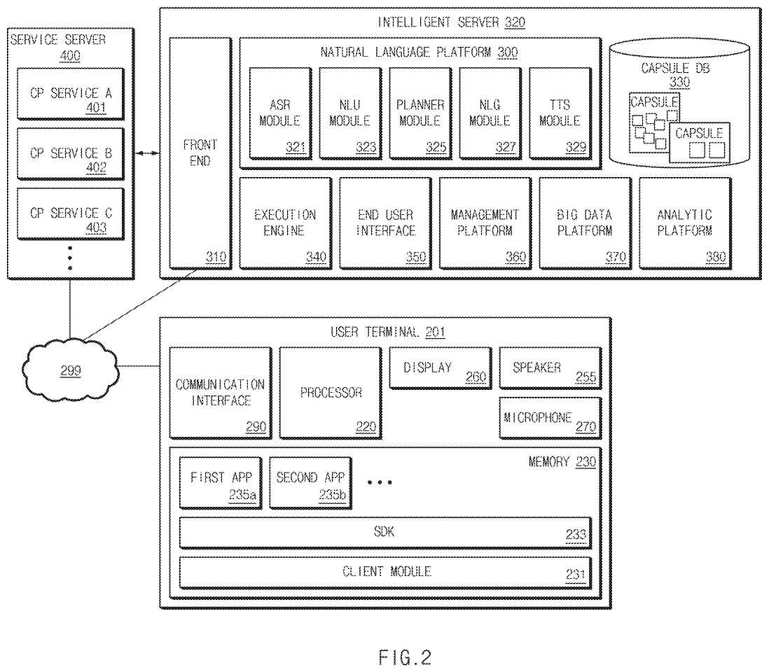

FIG. 2 is a block diagram illustrating an integrated intelligence system, according to an embodiment.

Referring to FIG. 2, an integrated intelligence system according to an embodiment may include a user terminal 201, an intelligence server 300, and a service server 400.

The user terminal 201 according to an embodiment may be a terminal device (or an electronic device) capable of connecting to Internet, and may be, for example, a mobile phone, a smartphone, a personal digital assistant (PDA), a notebook computer, a television (TV), a household appliance, a wearable device, a head mounted display (HMD), or a smart speaker.

According to the illustrated embodiment, the user terminal 201 may include a communication interface 290, a microphone 270, a speaker 255, a display 260, a memory 230, or a processor 220. The listed components may be operatively or electrically connected to one another.

The communication interface 290 according to an embodiment may be connected to an external device and may be configured to transmit or receive data to or from the external device. The microphone 270 according to an embodiment may receive a sound (e.g., a user utterance) to convert the sound into an electrical signal. The speaker 255 according to an embodiment may output the electrical signal as sound (e.g., voice). The display 260 according to an embodiment may be configured to display an image or a video. The display 260 according to an embodiment may display the graphic user interface (GUI) of the running app (or an application program).

The memory 230 according to an embodiment may store a client module 231, a software development kit (SDK) 233, and a plurality of apps 335. The client module 231 and the SDK 233 may constitute a framework (or a solution program) for performing general-purposed functions. Furthermore, the client module 231 or the SDK 233 may constitute the framework for processing a voice input.

The plurality of apps 235 may be programs for performing a specified function. According to an embodiment, the plurality of apps 235 may include a first app 235a and/or a second app 235_3. According to an embodiment, each of the plurality of apps 235 may include a plurality of actions for performing a specified function. For example, the apps may include an alarm app, a message app, and/or a schedule app. According to an embodiment, the plurality of apps 235 may be executed by the processor 220 to sequentially execute at least part of the plurality of actions.

According to an embodiment, the processor 220 may control overall operations of the user terminal 201. For example, the processor 220 may be electrically connected to the communication interface 290, the microphone 270, the speaker 255, and the display 260 to perform a specified operation. For example, the processor 220 may include at least one processor.

Moreover, the processor 220 according to an embodiment may execute the program stored in the memory 230 so as to perform a specified function. For example, according to an embodiment, the processor 220 may execute at least one of the client module 231 or the SDK 233 so as to perform a following operation for processing a voice input. The processor 220 may control operations of the plurality of apps 235 via the SDK 233. The following actions described as the actions of the client module 231 or the SDK 233 may be the actions performed by the execution of the processor 220.

According to an embodiment, the client module 231 may receive a voice input. For example, the client module 231 may receive a voice signal corresponding to a user utterance detected through the microphone 270. The client module 231 may transmit the received voice input (e.g., a voice input) to the intelligence server 300. The client module 231 may transmit state information of the user terminal 201 to the intelligence server 300 together with the received voice input. For example, the state information may be execution state information of an app.

According to an embodiment, the client module 231 may receive a result corresponding to the received voice input. For example, when the intelligence server 300 is capable of calculating the result corresponding to the received voice input, the client module 231 may receive the result corresponding to the received voice input. The client module 231 may display the received result on the display 260.

According to an embodiment, the client module 231 may receive a plan corresponding to the received voice input. The client module 231 may display, on the display 260, a result of executing a plurality of actions of an app depending on the plan. For example, the client module 231 may sequentially display the result of executing the plurality of actions on a display. For another example, the user terminal 201 may display only a part of results (e.g., a result of the last action) of executing the plurality of actions, on the display.

According to an embodiment, the client module 231 may receive a request for obtaining information necessary to calculate the result corresponding to a voice input, from the intelligence server 300. According to an embodiment, the client module 231 may transmit the necessary information to the intelligence server 300 in response to the request.

According to an embodiment, the client module 231 may transmit, to the intelligence server 300, information about the result of executing a plurality of actions depending on the plan. The intelligence server 300 may identify that the received voice input is correctly processed, using the result information.

According to an embodiment, the client module 231 may include a speech recognition module. According to an embodiment, the client module 231 may recognize a voice input for performing a limited function, via the speech recognition module. For example, the client module 231 may launch an intelligence app for processing a specific voice input by performing an organic action, in response to a specified voice input (e.g., wake up!).

According to an embodiment, the intelligence server 300 may receive information associated with a user's voice input from the user terminal 201 over a communication network 299. According to an embodiment, the intelligence server 300 may convert data associated with the received voice input to text data. According to an embodiment, the intelligence server 300 may generate at least one plan for performing a task corresponding to the user's voice input, based on the text data.

According to an embodiment, the plan may be generated by an artificial intelligent (AI) system. The AI system may be a rule-based system, or may be a neural network-based system (e.g., a feedforward neural network (FNN) and/or a recurrent neural network (RNN)). Alternatively, the AI system may be a combination of the above-described systems or an AI system different from the above-described system. According to an embodiment, the plan may be selected from a set of predefined plans or may be generated in real time in response to a user's request. For example, the AI system may select at least one plan of the plurality of predefined plans.

According to an embodiment, the intelligence server 300 may transmit a result according to the generated plan to the user terminal 201 or may transmit the generated plan to the user terminal 201. According to an embodiment, the user terminal 201 may display the result according to the plan, on a display. According to an embodiment, the user terminal 201 may display a result of executing the action according to the plan, on the display.

The intelligence server 300 according to an embodiment may include a front end 310, a natural language platform 320, a capsule database 330, an execution engine 340, an end user interface 350, a management platform 360, a big data platform 370, or an analytic platform 380.

According to an embodiment, the front end 310 may receive a voice input received from the user terminal 201. The front end 310 may transmit a response corresponding to the voice input to the user terminal 201.

According to an embodiment, the natural language platform 320 may include an automatic speech recognition (ASR) module 321, a natural language understanding (NLU) module 323, a planner module 325, a natural language generator (NLG) module 327, and/or a text to speech module (TTS) module 329.

According to an embodiment, the ASR module 321 may convert the voice input received from the user terminal 201 into text data. According to an embodiment, the NLU module 323 may grasp the intent of the user, using the text data of the voice input. For example, the NLU module 323 may grasp the intent of the user by performing syntactic analysis or semantic analysis. According to an embodiment, the NLU module 323 may grasp the meaning of words extracted from the voice input by using linguistic features (e.g., syntactic elements) such as morphemes or phrases and may determine the intent of the user by matching the grasped meaning of the words to the intent.

According to an embodiment, the planner module 325 may generate the plan by using a parameter and the intent that is determined by the NLU module 323. According to an embodiment, the planner module 325 may determine a plurality of domains necessary to perform a task, based on the determined intent. The planner module 325 may determine a plurality of actions included in each of the plurality of domains determined based on the intent. According to an embodiment, the planner module 325 may determine the parameter necessary to perform the determined plurality of actions or a result value output by the execution of the plurality of actions. The parameter and the result value may be defined as a concept of a specified form (or class). As such, the plan may include the plurality of actions and/or a plurality of concepts, which are determined by the intent of the user. The planner module 325 may determine the relationship between the plurality of actions and the plurality of concepts stepwise (or hierarchically). For example, the planner module 325 may determine the execution sequence of the plurality of actions, which are determined based on the user's intent, based on the plurality of concepts. In other words, the planner module 325 may determine an execution sequence of the plurality of actions, based on the parameters necessary to perform the plurality of actions and the result output by the execution of the plurality of actions. Accordingly, the planner module 325 may generate a plan including information (e.g., ontology) about the relationship between the plurality of actions and the plurality of concepts. The planner module 325 may generate the plan, using information stored in the capsule DB 330 storing a set of relationships between concepts and actions.

According to an embodiment, the NLG module 327 may change specified information into information in a text form. The information changed to the text form may be in the form of a natural language speech. The TTS module 329 according to an embodiment may change information in the text form to information in a voice form.

According to an embodiment, all or part of the functions of the natural language platform 320 may be also implemented in the user terminal 201.

The capsule DB 330 may store information about the relationship between the actions and the plurality of concepts corresponding to a plurality of domains. According to an embodiment, the capsule may include a plurality of action objects (or action information) and concept objects (or concept information) included in the plan. According to an embodiment, the capsule DB 330 may store the plurality of capsules in a form of a concept action network (CAN). According to an embodiment, the plurality of capsules may be stored in the function registry included in the capsule DB 330.

The capsule DB 330 may include a strategy registry that stores strategy information necessary to determine a plan corresponding to a voice input. When there are a plurality of plans corresponding to the voice input, the strategy information may include reference information for determining one plan. According to an embodiment, the capsule DB 330 may include a follow-up registry that stores information of the follow-up action for suggesting a follow-up action to the user in a specified context. For example, the follow-up action may include a follow-up utterance. According to an embodiment, the capsule DB 330 may include a layout registry storing layout information of information output via the user terminal 201. According to an embodiment, the capsule DB 330 may include a vocabulary registry storing vocabulary information included in capsule information. According to an embodiment, the capsule DB 330 may include a dialog registry storing information about dialog (or interaction) with the user. The capsule DB 330 may update an object stored via a developer tool. For example, the developer tool may include a function editor for updating an action object or a concept object. The developer tool may include a vocabulary editor for updating a vocabulary. The developer tool may include a strategy editor that generates and registers a strategy for determining the plan. The developer tool may include a dialog editor that creates a dialog with the user. The developer tool may include a follow-up editor capable of activating a follow-up target and editing the follow-up utterance for providing a hint. The follow-up target may be determined based on a target, the user's preference, or an environment condition, which is currently set. The capsule DB 330 according to an embodiment may be also implemented in the user terminal 201.

According to an embodiment, the execution engine 340 may calculate a result by using the generated plan. The end user interface 350 may transmit the calculated result to the user terminal 201. Accordingly, the user terminal 201 may receive the result and may provide the user with the received result. According to an embodiment, the management platform 360 may manage information used by the intelligence server 300. According to an embodiment, the big data platform 370 may collect data of the user. According to an embodiment, the analytic platform 380 may manage quality of service (QoS) of the intelligence server 300. For example, the analytic platform 380 may manage the component and processing speed (or efficiency) of the intelligence server 300.

According to an embodiment, the service server 400 may provide the user terminal 201 with a specified service (e.g., ordering food or booking a hotel). According to an embodiment, the service server 400 may be a server operated by the third party. According to an embodiment, the service server 400 may provide the intelligence server 300 with information for generating a plan corresponding to the received voice input. The provided information may be stored in the capsule DB 330. Furthermore, the service server 400 may provide the intelligence server 300 with result information according to the plan.

In the above-described integrated intelligence system, the user terminal 201 may provide the user with various intelligent services in response to a user input. The user input may include, for example, an input through a physical button, a touch input, or a voice input.

According to an embodiment, the user terminal 201 may provide a speech recognition service via an intelligence app (or a speech recognition app) stored therein. In this case, for example, the user terminal 201 may recognize a user utterance or a voice input, which is received via the microphone, and may provide the user with a service corresponding to the recognized voice input.

According to an embodiment, the user terminal 201 may perform a specified action, based on the received voice input, independently, or together with the intelligence server 300 and/or the service server 400. For example, the user terminal 201 may launch an app corresponding to the received voice input and may perform the specified action via the executed app.

According to an embodiment, when providing a service together with the intelligence server 300 and/or the service server 400, the user terminal 201 may detect a user utterance by using the microphone 270 and may generate a signal (or voice data) corresponding to the detected user utterance. The user terminal may transmit the voice data to the intelligence server 300 by using the communication interface 290.

According to an embodiment, the intelligence server 300 may generate a plan for performing a task corresponding to the voice input or the result of performing an action depending on the plan, as a response to the voice input received from the user terminal 201. For example, the plan may include a plurality of actions for performing the task corresponding to the voice input of the user and/or a plurality of concepts associated with the plurality of actions. The concept may define a parameter to be input upon executing the plurality of actions or a result value output by the execution of the plurality of actions. The plan may include relationship information between the plurality of actions and/or the plurality of concepts.

According to an embodiment, the user terminal 201 may receive the response by using the communication interface 290. The user terminal 201 may output the voice signal generated in the user terminal 201 to the outside by using the speaker 255 or may output an image generated in the user terminal 201 to the outside by using the display 260.

In FIG. 2, it is described that speech recognition of a voice input received from the user terminal 201, understanding and generating a natural language, and calculating a result by using a plan are performed on the intelligence server 300. However, various embodiments of the disclosure are not limited thereto. For example, at least part of configurations (e.g., the natural language platform 320, the execution engine 340, and the capsule DB 330) of the intelligence server 300 may be embedded in the user terminal 201 (or the electronic device 101 of FIG. 1), and the operation thereof may be performed by the user terminal 201.

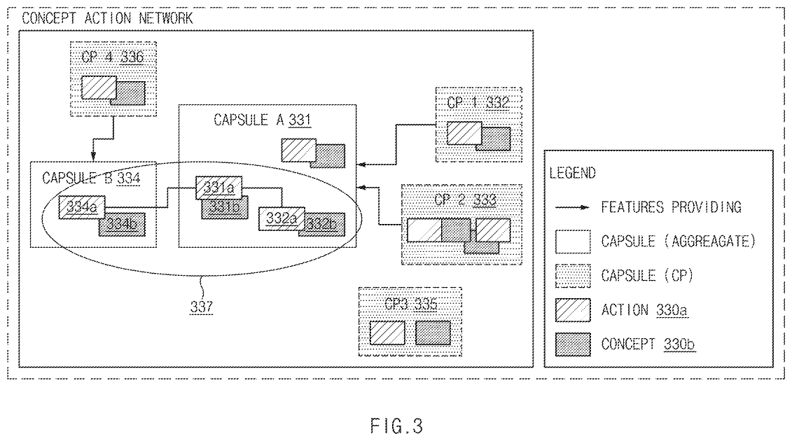

FIG. 3 is a diagram illustrating a form in which relationship information between a concept and an action is stored in a database, according to various embodiments.

A capsule database (e.g., the capsule DB 330) of the intelligence server 200 may store a capsule in the form of a CAN. The capsule DB may store an action for processing a task corresponding to a user's voice input and a parameter necessary for the action, in the CAN form.

The capsule DB may store a plurality capsules (a capsule A 331 and a capsule B 334) respectively corresponding to a plurality of domains (e.g., applications). According to an embodiment, a single capsule (e.g., the capsule A 331) may correspond to a single domain (e.g., a location (geo) or an application). Furthermore, at least one service provider (e.g., CP 1 332 or CP 2 333) for performing a function for a domain associated with the capsule may correspond to one capsule. According to an embodiment, the single capsule may include at least one or more actions 330a and at least one or more concepts 330b for performing a specified function.

The natural language platform 220 may generate a plan for performing a task corresponding to the received voice input, using the capsule stored in a capsule database. For example, the planner module 225 of the natural language platform may generate the plan by using the capsule stored in the capsule database. For example, a plan 337 may be generated by using actions 331a and 332a and concepts 331b and 332b of the capsule A 330a and an action 334a and a concept 334b of the capsule B 334.

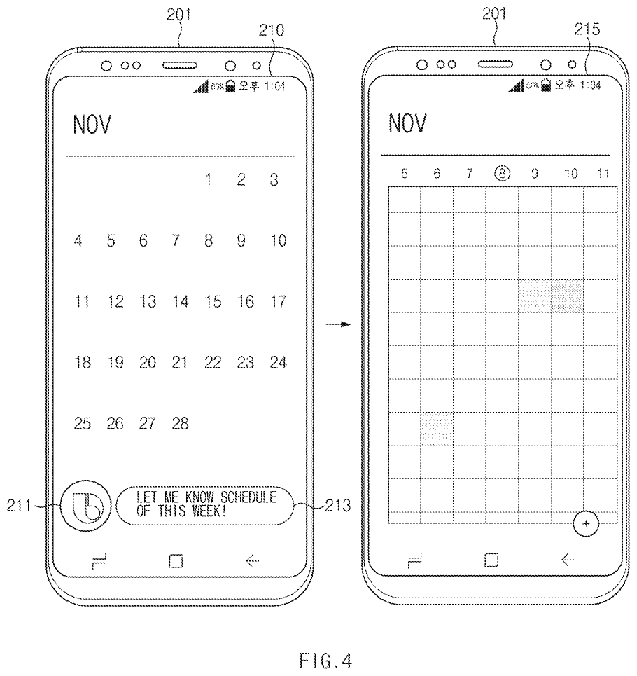

FIG. 4 is a view illustrating a screen in which a user terminal processes a voice input received through an intelligence app, according to various embodiments.

The user terminal 201 may execute an intelligence app to process a user input through the intelligence server 200.

According to an embodiment, on screen 210, when recognizing a specified voice input (e.g., wake up!) or receiving an input via a hardware key (e.g., a dedicated hardware key), the user terminal 201 may launch an intelligence app for processing a voice input. For example, the user terminal 201 may launch the intelligence app in a state where a schedule app is executed. According to an embodiment, the user terminal 201 may display an object (e.g., an icon) 211 corresponding to the intelligence app, on the display 340. According to an embodiment, the user terminal 201 may receive a voice input by a user utterance. For example, the user terminal 201 may receive a voice input saying that “let me know the schedule of this week!”. According to an embodiment, the user terminal 201 may display a user interface (UI) 213 (e.g., an input window) of the intelligence app, in which text data of the received voice input is displayed, on a display.

According to an embodiment, on screen 215, the user terminal 201 may display a result corresponding to the received voice input, on the display. For example, the user terminal 201 may receive a plan corresponding to the received user input and may display ‘the schedule of this week’ on the display depending on the plan.

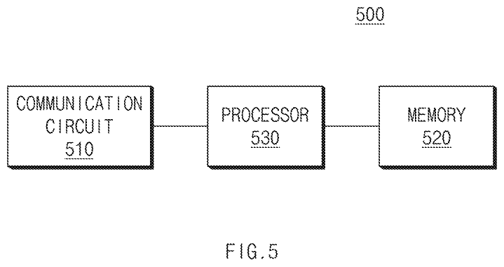

FIG. 5 is a block diagram of an electronic device 500, according to an embodiment.

An electronic device 500 (e.g., the electronic device 101 or the server 108 of FIG. 1, or the intelligence server 300 and/or the service server 400 of FIG. 2) according to an embodiment may include a communication circuit 510 (e.g., the communication module 190 of FIG. 1), a memory 520 (e.g., the memory 130 of FIG. 1), and/or a processor 530 (e.g., the processor 120 of FIG. 1).

According to an embodiment, the communication circuit 510 may establish communication with an external electronic device (e.g., the electronic device 101, 102, or 104 of FIG. 1 or the user terminal 201 of FIGS. 2 to 4). For example, the communication circuit 510 may transmit data to and/or receive data from the external electronic device. For example, the communication circuit 510 may receive a user's voice input (e.g., a voice command) from an external electronic device (e.g., a user terminal) and/or may transmit a command that causes the external electronic device (e.g., a target device) to perform a specified operation. For example, the communication circuit 510 may receive information related to a state of the external electronic device (e.g., the target device and/or a cloud server connected to the target device) and/or information related to a result obtained as the external electronic device performs an action corresponding to a voice input.

According to an embodiment, the memory 520 may store instructions that, when executed by the processor 530, cause the processor 530 to control an operation of the electronic device 500. According to an embodiment, the memory 520 may at least temporarily store data used to perform an operation of the electronic device 500. According to an embodiment, the memory 520 may store voice metadata. For example, the memory 520 may store at least one voice metadata corresponding to various devices and functions in advance. For example, the voice metadata may be set or produced in advance by a device developer (manufacturer) and may be distributed. According to an embodiment, the memory 520 may store the voice metadata in a form of an object (e.g., JavaScript Object Notation (JSON) file).

According to an embodiment, the processor 530 may receive the user's voice input from the external electronic device (e.g., a user terminal) through the communication circuit 510. According to an embodiment, the processor 530 may perform speech recognition (e.g., natural language understanding (NLU)) on a voice input. For example, the processor 530 may recognize target device-related information (e.g., an identifier (ID), a vendor identification (VID), a name, and/or the type of a target device) and user intent based on the voice input through NLU processing. For example, the processor 530 may extract the user intent from the voice input through NLU processing.

According to an embodiment, the processor 530 may recognize the user intent and the target device, which may perform an action corresponding to the voice input, based on the user's voice input. For example, the processor 530 may recognize information of the target device based on the voice input. According to an embodiment, the information of the target device may include at least one of the type of the target device, a name of the target device, ID of the target device, manufacturer information of the target device, or a vendor ID of the target device. According to an embodiment, the user intent may include at least one of voice capability information, voice action information, and parameter information related to an action corresponding to the voice input. According to an embodiment, the user intent may have a form of a string including voice capability information, voice action information, and/or parameter information. For example, the voice capability information may include information indicating a function of a device, and the voice action information may include information about how to operate the function of the device. For example, the parameter information may include additional information for operating a device, and may be omitted from the user intent.

For example, Table 1 shows an example of user intent when the target device is a TV, but the user intent is not limited thereto.

TABLE 1

| Voice capability | Voice action | Parameter | Descriptions |
|---|---|---|---|
| PowerSwitch | On | None | Power on |
| PowerSwitch | Off | None | Power off |
| Channel | Set | 11 | Channel setting (No. 11) |

According to an embodiment, the processor 530 may create and/or convert user intent in a specified format (e.g., JSON).

According to an embodiment, the processor 530 may transmit a command (e.g., an Internet of things (IoT) command), which handles the user intent and performs an action corresponding to the voice input, to the target device. For example, the processor 530 may transmit a command to the target device and/or a cloud server connected to the target device, based on the user intent and information of the target device.

According to an embodiment, the processor 530 may recognize voice metadata based on the user intent and/or the information about to the target device. For example, the processor 530 may recognize the voice metadata corresponding to the user's voice input. According to an embodiment, the voice metadata may be a file in a specified format (e.g., JSON format) configured to be executable by the processor 530. For example, the voice metadata may include a code that is executed by the processor 530 to process a voice command. According to an embodiment, the voice metadata may include information (e.g., VID) of a device that will use voice metadata, information of voice capability, and/or information of a voice action. According to an embodiment, the voice metadata may include JSON text. According to an embodiment, the voice metadata may include a plurality of nodes, each of which is the smallest logical unit that performs a function.

According to an embodiment, the processor 530 may determine, based on the voice metadata, whether there is a precondition to perform an action corresponding to a voice input. For example, when the user's voice input is “set quick cooling of an air conditioner,” there may be a need for a precondition, such as turning on the air conditioner, for the purpose of performing ‘setting the air conditioner to a quick cooling function’ corresponding to the user's voice input.

According to an embodiment, when there is a precondition to perform an action corresponding to the voice input, the processor 530 may identify the state of the target device related to the precondition. For example, the electronic device 500 may make a request for state information related to a precondition to the target device and may receive the state information from the target device. For example, the electronic device 500 may obtain the state information of the target device through the cloud server connected to the target device. For example, the electronic device 500 may obtain information about a power state of the target device from the target device (e.g., an air conditioner) with regard to the precondition (e.g., ‘a state where an air conditioner is powered on’) for setting the air conditioner to quick cooling. For example, the electronic device 500 may obtain state information indicating whether the target device is powered on or off.

According to an embodiment, the processor 530 may determine whether the state of the target device satisfies the precondition. For example, on the basis of the state information of the target device (e.g., an air conditioner), the processor 530 may determine that the precondition is not satisfied (e.g., when recognizing that the air conditioner is powered off) and may determine that the precondition is satisfied (e.g., when recognizing that the air conditioner is on).

According to an embodiment, responsive to determining that the state of the target device does not satisfy the precondition, the processor 530 may transmit a command that performs an action corresponding to the precondition to the target device, based on voice metadata. According to an embodiment, the target device may include an IoT device connected to a cloud server. According to an embodiment, the processor 530 may transmit a command, which provides for the target device to perform an action corresponding to the precondition, to the cloud server. The cloud server may deliver the command for performing the action corresponding to the precondition to the target device.

According to an embodiment, responsive to determining that the state of the target device satisfies the precondition, the processor 530 may transmit a command for performing an action corresponding to a voice input to the target device. According to an embodiment, the processor 530 may transmit a command, which allows the target device to perform an action corresponding to the voice input, to the cloud server. The cloud server may deliver a command for performing an action corresponding to the voice input to the target device. According to an embodiment, responsive to there being no precondition to perform an action corresponding to the voice input, the processor 530 may transmit a command for directly performing an action corresponding to the voice input to the target device without identifying the state of the target device.

According to an embodiment, responsive to the target device performing an action (e.g., an action corresponding to a precondition and/or an action corresponding to a voice input) corresponding to the command, the processor 530 may provide the action execution result to the external electronic device. For example, the processor 530 may receive a response indicating the result of performing the action from the target device through the communication circuit 510. For example, the processor 530 may provide the response indicating the result of performing the action of the target device to the external electronic device through the communication circuit 510.

According to an embodiment, the electronic device 500 may further include at least part of the configuration of the electronic device 101 of FIG. 1, the server 108 of FIG. 1, the intelligence server 300 of FIG. 2, or the service server 400 of FIG. 2.

According to an embodiment of the disclosure, when it is desired to perform an action corresponding to a precondition to perform an action corresponding to a user's voice input, the electronic device 500 may perform an action corresponding to the voice input after performing a condition corresponding to the precondition without an additional input of a user, thereby smoothly providing a voice assistant service matching the user's intent.

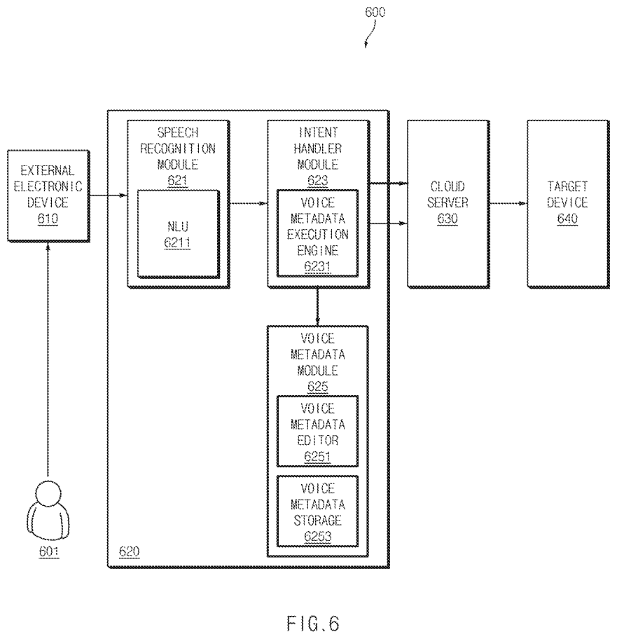

FIG. 6 is a diagram illustrating an artificial intelligence assistant system 600, according to an embodiment.

According to an embodiment, an artificial intelligence assistant system 600 (e.g., the integrated intelligence system of FIG. 2) may include an external electronic device 610 (e.g., a user terminal (e.g., the electronic device 101 of FIG. 1 or the user terminal 201 of FIGS. 2 to 4), an electronic device 620 (e.g., the electronic device 101 of FIG. 1 or the server 108, the intelligence server 300 and/or the service server 400 of FIG. 2, or the electronic device 500 of FIG. 5), a cloud server 630 (e.g., the server 108 of FIG. 1), and/or a target device 640.

According to an embodiment, the external electronic device 610 may receive a user's voice input through a microphone. According to an embodiment, the external electronic device 610 may deliver the voice input of a user 601 to the electronic device 620. For example, the external electronic device 610 may convert the user's voice received through the microphone into voice data and may transmit the voice data to the electronic device 620.

According to an embodiment, a speech recognition module 621 may include an NLU module 6211. For example, the speech recognition module 621 (e.g., the NLU module 6211) may analyze a voice input of the user 601 and may recognize information (e.g., an ID of a target device, a name of a target device, and/or the type of a target device) related to the target device 640 and/or user intent. For example, the speech recognition module 621 may extract the user intent from a voice input of the user 601. According to an embodiment, the speech recognition module 621 may deliver the information related to the target device 640 and/or the user intent to an intent handler module 623.

According to an embodiment, the intent handler module 623 may include a voice metadata execution engine 6231. According to an embodiment, the voice metadata execution engine 6231 of the intent handler module 623 may include a library module that executes the content (e.g., a code of voice metadata) of voice metadata at runtime. According to an embodiment, the voice metadata may include additional information, which it is difficult to obtain from a voice input (e.g., the user intent extracted from the voice input) of the user 601. According to an embodiment, the voice metadata may be data previously generated by a device developer. According to an embodiment, the voice metadata may include an execution file in a specified format (e.g., JSON format). According to an embodiment, the intent handler module 623 may transmit, to the target device 640 (e.g., directly or via the cloud server 630), a command for determining a precondition for performing an action corresponding to the user's voice input and performing the precondition and/or a command for performing an action corresponding to a user input, by executing the voice metadata corresponding to the voice input (e.g., user intent) of the user 601 by using the voice metadata execution engine 6231. For example, the intent handler module 623 may execute voice metadata at runtime by using the voice metadata execution engine 6231.

According to an embodiment, the intent handler module 623 may determine a command for performing a function corresponding to the user's voice input based at least partly on the user intent received from the speech recognition module 621. According to an embodiment, the intent handler module 623 may determine the target device 640 based at least partly on the user intent. For example, the intent handler module 623 may determine a command and the target device 640, which correspond to the voice input of the user 601. For example, the intent handler module 623 may recognize the cloud server 630 connected to the target device 640. According to an embodiment, the intent handler module 623 may transmit a command that provides for the target device 640 performing an action corresponding to the user's voice input to the cloud server 630 connected to the target device 640. According to an embodiment, the cloud server 630 may transmit a command for performing an action corresponding to the user's voice input to the target device 640.

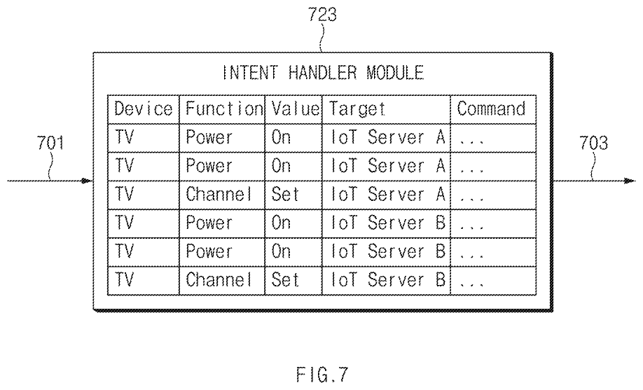

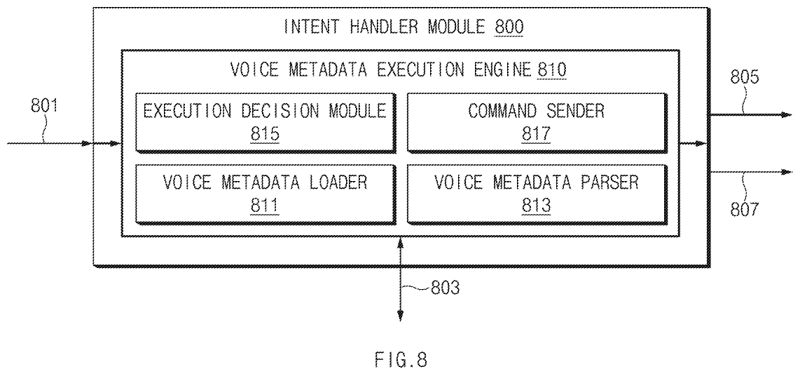

According to an embodiment, the intent handler module 623 may determine whether a precondition is present to perform an action corresponding to the user's voice input, based at least partly on the user intent. According to an embodiment, the intent handler module 623 may obtain voice metadata corresponding to the user intent from a voice metadata module 625. According to an embodiment, the intent handler module 623 may determine whether a precondition is present to perform an action corresponding to a voice input based on the voice metadata. According to an embodiment, where a precondition is present, the intent handler module 623 may transmit a command for performing an action corresponding to the precondition to the cloud server 630 connected to the target device 640. According to an embodiment, the cloud server 630 may deliver a command for performing an action corresponding to the precondition to the target device 640. According to an embodiment, the intent handler module 623 may directly transmit a command for performing an action corresponding to the user's voice input and/or a command for performing an action corresponding to a precondition to the target device 640 without going through the cloud server 630. Hereinafter, an operation of the intent handler module 623 in FIGS. 7 and 8 will be described in more detail.

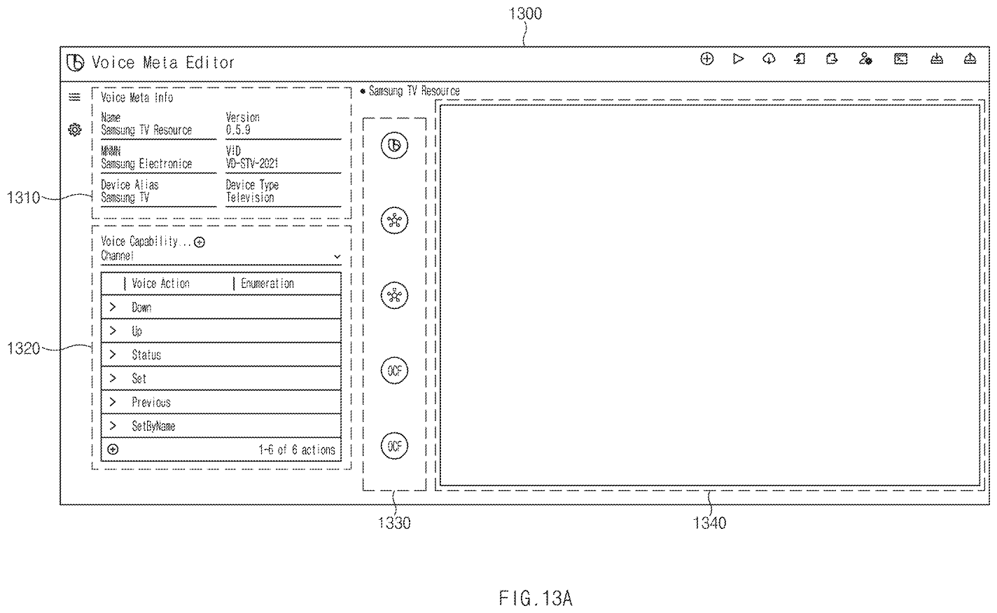

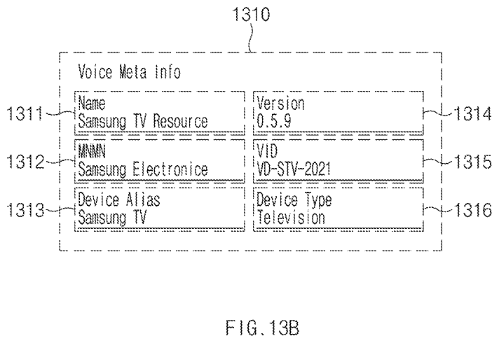

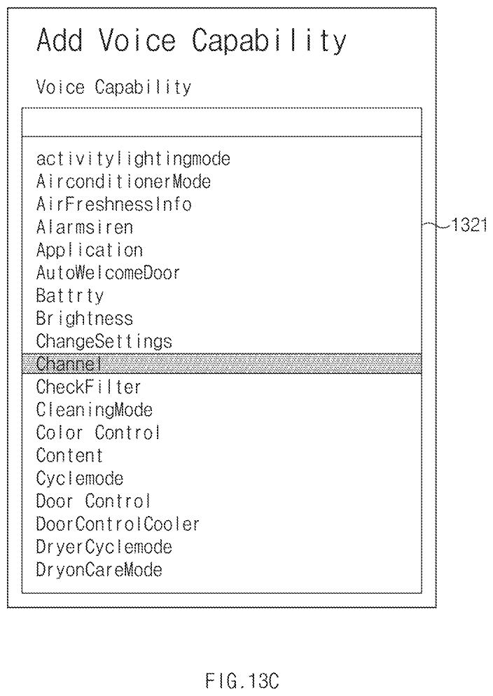

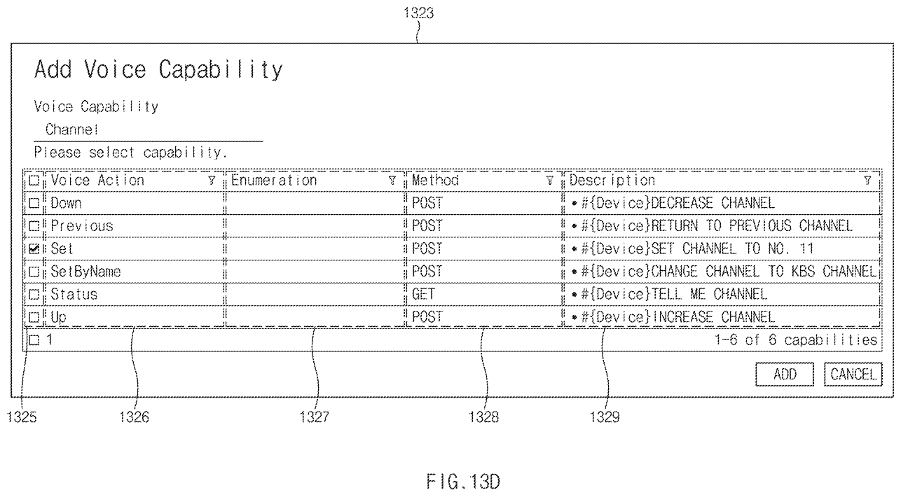

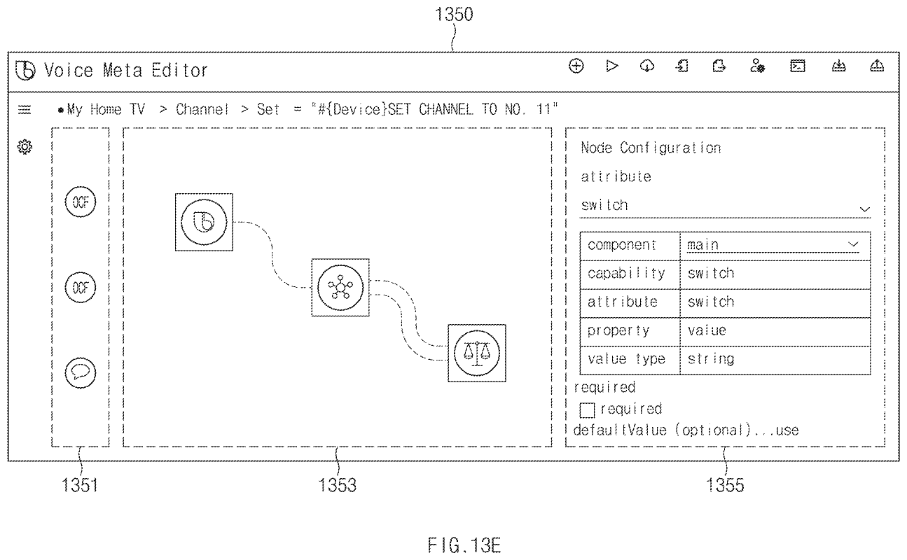

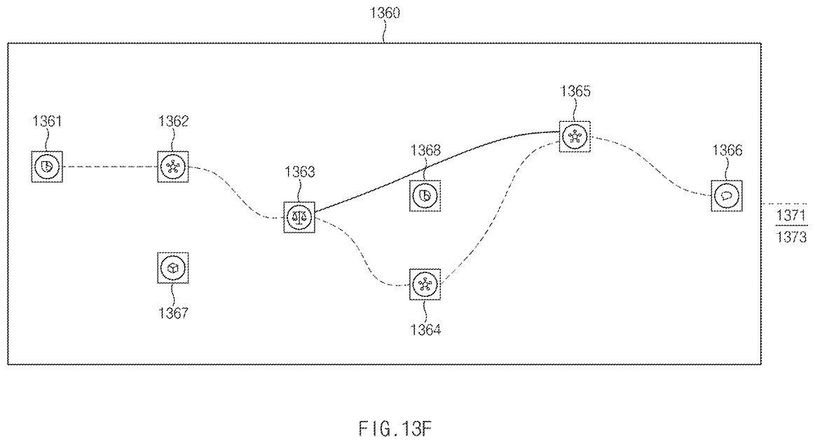

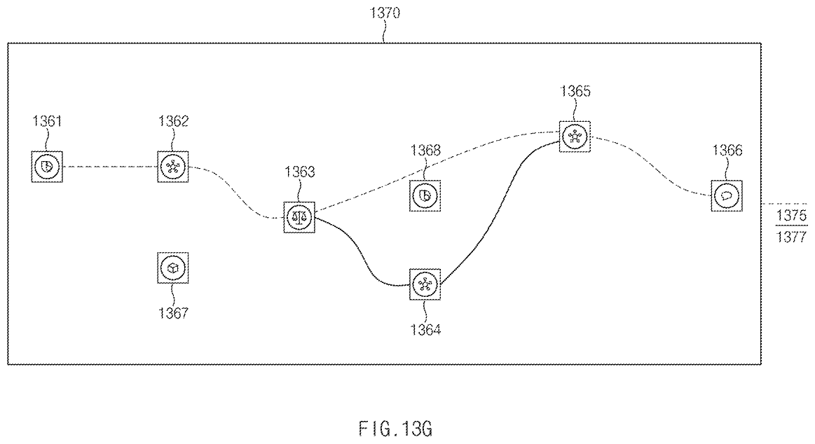

According to an embodiment, the voice metadata module 625 may include a voice metadata editor 6251 and voice metadata storage 6253. According to an embodiment, the voice metadata editor 6251 may include one or more user interfaces (e.g., an Internet site, an application, a program, and/or a voice metadata editing tool) provided by the voice metadata module 625. Hereinafter, an operation of generating voice metadata by using the voice metadata editor 6251 will be described in more detail with reference to FIGS. 13A to 13G. According to an embodiment, the voice metadata storage 6253 may be included in a memory of the voice metadata module 625.

According to various embodiments, at least part of each configuration (e.g., the speech recognition module 621, the intent handler module 623, or the voice metadata module 625) of the electronic device 620 may be implemented as a separate server, or may be implemented as an integrated server. According to an embodiment, at least part of the speech recognition module 621, the intent handler module 623, or the voice metadata module 625 may be integrated into a processor (e.g., the processor 120 of FIG. 1 or the processor 530 of FIG. 5) of the electronic device 620. For example, the above-described operations of the speech recognition module 621, the intent handler module 623, or the voice metadata module 625 may be performed by the processor of the electronic device 620. According to an embodiment, the external electronic device 610 (e.g., a user terminal) and the electronic device 620 may be integrated with each other. For example, a single device may be implemented to perform both an operation of receiving a user's voice input of the external electronic device 610 and an operation of an artificial intelligence assistant of the electronic device 620.

FIG. 7 is a diagram for describing an operation of an intent handler module 723, according to an embodiment.

According to an embodiment, an intent handler module 723 (e.g., the intent handler module 623 of FIG. 6) may receive user intent 701 from a speech recognition module (not shown) (e.g., the speech recognition module 621 of FIG. 6). According to an embodiment, the intent handler module 723 may receive information of a target device from the speech recognition module. According to an embodiment, the intent handler module 723 may determine a command to be transmitted to the target device (e.g., the target device 640 in FIG. 6) based on user intent. For example, on the basis of the user intent, the intent handler module 723 may determine at least one of the type of a target device, a function of the target device, a setting value, information of a cloud server connected to the target device, or a command to be transmitted to the target device. For example, the intent handler module 723 may determine information (device) of a device, a function (function) of a device, a set value (value), a target device (an IoT cloud server connected to the target device) (target), and/or a command (command). According to an embodiment, the intent handler module 723 may transmit a command 703 for performing an action (i.e., an action corresponding to user intent) corresponding to a user's voice input to the target device (or the cloud server connected to the target device) based on the determined information.

According to an embodiment, a precondition may be present to perform an action corresponding to the user intent corresponding to the user's voice input. For example, when the user utters a voice input for changing TV channel, the precondition (e.g., turning on a TV) may be present to perform an action (e.g., changing TV channel) corresponding to the user's voice input. According to an embodiment, the intent handler module 723 (e.g., a voice metadata execution engine) may determine whether a precondition is present to perform an action corresponding to the user's voice input. For example, the intent handler module 723 may obtain voice metadata corresponding to the user intent from a voice metadata module (e.g., the voice metadata module 625 of FIG. 6) and may determine whether a precondition is present to perform an action corresponding to a voice input based on the voice metadata. For example, the intent handler module 723 may determine at least one of information (device) of a device, a function (function) of a device, a set value (value), a target device (an IoT cloud server connected to the target device) (target), and/or a command (command) to perform the action corresponding to a precondition responsive to the precondition being present. According to an embodiment, the intent handler module 723 may transmit a command 703 for performing an action corresponding to the precondition to the target device (or the cloud server connected to the target device) based on the determined information. According to an embodiment, responsive to there being a precondition to perform an action corresponding to the user's voice input, the target device may first perform an action corresponding to the precondition, and then the intent handler module 723 may allow the target device to perform an action corresponding to the user's voice input. According to an embodiment, the intent handler module 723 may recognize the state of the target device. Responsive to there being no precondition for performing an action corresponding to the user's voice input (e.g., when the user utters a voice input, which does not require a precondition, such as “turn on TV”), or responsive to the precondition already being satisfied (e.g., when the user utters the voice input of “lower the temperature of the air conditioner,” or when the precondition of “a state where an air conditioner is powered on” is already satisfied), the intent handler module 723 may transmit a command for performing an action corresponding to the user's voice input to the target device.

FIG. 8 is a diagram for describing an operation of an intent handler module 800, according to an embodiment.

According to an embodiment, an intent handler module 800 (e.g., the intent handler module 623 of FIG. 6 or the intent handler module 723 of FIG. 7) may include a voice metadata execution engine 810 (e.g., the voice metadata execution engine 6231 of FIG. 6). According to an embodiment, the voice metadata execution engine 810 of the intent handler module 800 may include a library module that executes the content (e.g., a code of voice metadata) of voice metadata at runtime.

According to an embodiment, terms in Table 2 below may be defined in relation to the voice metadata.

```
TABLE 2
* Device
    - It refers to a device (e.g., an loT device or a target device).
    (e.g., an air conditioner, a vacuum cleaner, a lighting, or a blind)
* Capability (a concept different from voice capability)
    - It means functional properties of a device.
    Example 1) Volume: volume property or volume capability may be set
for TV, radio, speaker, and mobile device.
    Example 2) Channel: a value used to indicate each broadcast when a
user may watch or listen to n broadcasts through one device. For example,
channel capability may be set for TV or a radio, but channel capability may
not be set for a speaker or a mobile device.
    - Capability is a standardized specification and does not depend on a
specific device. For example, dimming level capability may be used to
indicate the brightness of lighting or an extent to which a blind is folded.
* Action
    - One capability may include n actions.
    Example 1) Volume may include actions of up (volume up), down
(volume down), and set (set to a specific value).
    Example 2) Channel may include actions of up (go to the next
channel), down (go to the previous channel), and set (set to a specific
channel).
* VID
    - Vendor ID
    - At the time of executing voice metadata, an electronic device (e.g., a
voice metadata execution engine) may search for the VID of a device
owned by a user based on user information.
    - The VID may be used to identify one specific metadata among
previously stored voice metadata.
* Voice metadata
    - Including JSON text for implementing execution logic of a device.
    - One device may use one voice metadata
    - One voice metadata is available for n devices. For example, TVs that
have released at the same time and have the same VID (e.g., VD-STD-2021
VID) may use the same voice metadata corresponding to VID.
* Node
    - It is the smallest logical unit that performs a function, as a unit
constituting voice metadata.
    - In a user interface (e.g., a voice metadata editor), it may be expressed
as an object of a specified type.
    Example 1) Start node: a node that is first executed when voice
metadata (e.g., graph) is executed.
    Example 2) Capability command node: a node that transmits a device
control command to a device based on an loT capability specification.
* Graph
    - A logical unit expressing the execution order of n nodes by
connecting lines.
```

According to an embodiment, a specification shown in Table 3 below may be referred to in relation to the voice metadata. For example, the voice metadata may be implemented with JSON text as shown in Table 3 below. According to an embodiment, the following description is an example for the specification of voice metadata, but is not limited thereto.

```
TABLE 3
{
  “n”: “Samsung TV Resource”, // A name of a voice metadata file. A value
freely entered by a device developer to identify a purpose of voice metadata.
  “version”: “0.0.1”, // A version of the voice metadata file. Version update
whenever voice metadata is modified (commenting incremented version)
  “mnmn”: “Samsung Electronics”, // Manufacturer information
  “vid”: “VD-STV-2021”, // product (device) ID of a manufacturer or vendor
ID (VID)
  “dalias”: “Samsung Airpurifier”, // a nickname of a device
  “dtype”: “AirPurifier”, // the type of a device
  “schemaVersion”: “2.0”, // A specification version of a syntax of a current
voice metadata file
  “sml”: [ // Definition of an action and a graph for each capability of a device
    {
      “capability”: “Volume”, // TV volume-related capability
      “voiceActions”: [
        {
          “action”: “Set”, // an action of setting TV volume
          ...(skip)...
        }
      ]
    },
  {
    “capability”: “Channel”, // TV channel-related capability
    “voiceActions”: [
      {
      “action”: “Set”, // an action of setting TV channel to No. n
      “graph”: {
        “graph”: {
          “graphld”: “14c5bcaf-9cad-49ed-94da-847f976f5da8”, // Graph
unique ID
          “version”: “0.0.1”, // A version of an engine (e.g., a voice metadata
execution engine) in which voice metadata is executed
          “userAgent”: {
            “id”: ″IntelligenceDe signer”, // A name of a tool (e.g., a voice
metadata editor) that created a graph
            “version”: “1.0.0” // A version of a tool
          },
          “nodes”: [ // A node list inside a graph
            {
              “nodeld”: “cdcd0333-laf5-4d65-b014-6d96feeb59e8”, // A
unique ID of a node. In a graph, every node indicates the next node to be
executed after it is executed by using a unique ID.
              “nodeVer”: “1.0”, // A specification version of a node
              “nodeType”: “start”, // The type of a node. The start node is the
first node to be executed, and the next node pointed by the start node is
executed without any special operation.
              “isStateful”: true, // after a result of executing a node is stored, the
result is used when a graph is executed again.
              “isTriggerOnChange”: false, // After a node is executed, the next
node is executed only when the result of the previous execution is different
from the result of the current execution.
              “group”: null, // It is used when nodes are grouped.
              “inputPorts”: { }, // Enter a unique ID of another node to be used
as an input when the corresponding node is executed.
              “triggerPorts”: { // Enter a unique ID of the next node to be
executed after the corresponding node is executed.
              “main”: { // Default setting. A default value is expressed as a
main.
                “nodes”: [
                  “713fedl8-a99a-4413-9426-879055a84dc5” // 713fedl8-
a99a-4413-9426-879055a84dc5 is the unique ID of one of the other nodes
included in the current graph.
                ]
              }
            },
            “styles”: { // A value of a node’s position on a user interface (UI)
of an editor (a voice metadata editor). A value for showing the UI in the same
layout when other people load the corresponding voice metadata in the editor,
            “x”: 215,
            “y”: 480
          }
        },
        {
          “nodeld”: “713fed 18-a99a-4413-9426-879055a84dc5”,
          “nodeVer”: “1.0”,
          “nodeType”: “capability Attribute”, // “capabilityAttribute” is a
node that gets (calls) the current state value of an IoT device.
          “isStateful”: true,
          “isTriggerOnChange”: false,
          “group”: null,
          “inputPorts”: { },
          “triggerPorts”: { // Port names such as “success” and “failure”
described below may only be used at specific nodes.
          “success”: { // A unique ID of the node to be executed when the
current value of the loT device is normally obtained, “success” port is present
only in “capabilityAttribute”.
            “nodes”: [
              “5567c7d9-7566-45ea-8aab-1361b7271d83”
            ]
          }
          “failure”: { // A unique ID of the node to be executed when the
current value of the loT device may not be obtained normally.
            “nodes”: [ ]
          }
        },
        “configurations”: { // A node's setting value. Available
configuration is different depending on Node Type, “attribute” and “required”
are the names of the configuration.
          “attribute”: { // including information about whether a function
of getting a state value of a device is performed after an loT command is
created in a specific format when the corresponding node is executed. The
following is a configuration used to get a power value of a device.
            “dataType”: “datatype.schema.AFCapabilityAttribute”, // a
data type to be used when running in an execution engine (e.g., a voice
metadata execution engine).
            “dataValue”: { //A value to be stored in a data type
“datatype, schema. AFCapability Attribute”.
              “component”: “main”, // A group of features of a device.
              “capability”: “switch”, // Device power switch capability
              “attribute”: “switch”, // Attributes of the device power switch
capability
              “property”: {
                “name”: “value”,
                “dataType”: “datatype.primitive.AFString”//
Datatype.primitive.AFString is used because a property value of capability is
defined as a string “on” or “off” in a data type.
                  }
                }
              },
              “required”: { // Whether the required setting value of a
capability Attribute node will generate an error when the current value of the
IoT device is not obtained when the node is executed.
                “dataType”: “datatype.primitive.AFBoolean”,
                “dataValue”: true
              }
            },
            “styles”: {
              “x”: 465,
              “y”: 262.1953125
            }
          },
          {
            “nodeId”: “5567c7d9-7566-45ea-8aab-1361b7271d83”,
            “nodeVer”: “1.0”,
            “nodeType”: “equalComparison”,
            “isStateful”: true,
            “isTriggerOnChange”: false,
            “group”: null,2dd18211-3178-412c-a581 -04f16465086d
            “inputPorts”: {2dd18211-3178-412c-a581-04f16465086d
              “leftValue”: { // Because “equalComparison” performs a
function of comparing two values entered as inputs, there are input ports
called “leftValue” and an input port called “rightValue”.
              “nodes”: [
                “713fedl8-a99a-4413-9426-879055a84dc5” // Because it is a
unique ID of a node of “capabilityAttribute”, a value for the current power
state of the device is used here.
              ]
            },
            “rightValue”: {
              “nodes”: [
                “2ddl8211-3178-412c-a581-04fl6465086d” // A unique ID
of “constant” node defined at a back side and a fixed value of “on” are stored.
              ]
            }
          },
          “triggerPorts”: {
            “true”: { // When a result value is true after equalComparison is
executed, a node executed here is executed.
              “nodes”: [
                “c6030f81-127a-4340-a70c-49c42cf2dc5c”
                ]
              ),
              “false”: { // When a result value is false after equalComparison
is executed, a node executed here is executed.
                “nodes”: [
                  “d02fcd27-cl78-4ff6-8a6a-b43ecdf5d157”
                ]
              }
            },
            “configurations”: {
              “operator”: { // Indicating what function equalComparison will
perform. equalTo (same) or notEqualTo (different) may be performed.
                “dataType”: “datatype.operator. EqualComparisonOperator”,
                “dataValue”: “equalTo”
              }
            },
            “styles”: {
              “x”: 695,
              “y”: 349.72265625
            }
          },
          {
            “nodeId”: “2ddl821 l-3178-412c-a581-04fl6465086d”,
            “nodeVer”: “1.0”,
            “nodeType”: “constant”,
            “isStateful”: true,
            “isTriggerOnChange”: false,
            “group”: null,
            “inputPorts”: { },
            “triggerPorts”: { // A “constant” node has no next node to be
executed. However, when another node uses the value of this node as an input,
the other node will be executed at reference time.
            “main”: {
              “nodes”: [ ]
            }
          },
          “configurations”: { // A data type of a fixed constant value (letter,
number, boolean,..) is a string. The stored value is “on”.
            “value”: {
              “dataType”: “datatype.primitive.AFString”,
              “dataValue”: “on”
            }
          },
          “styles”: {
              “x”: 475,
              “y”: 440
              }
          },
          {
            “nodeId”: “c6030f81-127a-4340-a70c-49c42cf2dc5c”,
            “nodeVer”: “1.0”,
            “nodeType”: “capabilityCommand”, // A node that performs a
function of sending a device control command.
            ″isStateful″: true,
            “isTriggerOnChange”: false,
            “group”: null,
            “inputPorts”: {
            ″tv Channel″: {
              “nodes”: [
                “4ef5e297-f6al-436d-b977-cb8b0238051c” // A result value
of a “parameter” node is used as a channel number. The “parameter” node
stores a value extracted from a user’s utterance, and value “11” in “Change a
channel to No. 11” is filled with a node’s value at runtime.
              ],
              “portinfo”: { // Port information. As an input, a result value of
n nodes may be used, and only one (4ef5e297-f6al-436d-b977-
cb8b0238051c) may be defined depending on a definition below.
                “dataTypes”: [
                  “undefined”
                ],
                “minitems”: 1,
                “maxitems”: 1
              }
            }
          },
          “triggerPorts”: {
            “success”: {
              “nodes”: [
                “8b0e703d-94bl-4fc2-8dbd-6e5bd8bfe475” // The next node
unique ID to be executed when a channel changing command is performed.
              ]
            },
          },
          “failure”: {
            “nodes”: [ ]
          }
        },
        “configurations”: {
          “command”: {// An loT command transmitted by Node
“capabilityCommand” is received as a configuration.
            “dataType”: “datatype, schema. AFCapabilityCommand”,
                “dataValue”: {
                  “component”: “main”, // A group of features of a device.
                  “capability”: “tvChannel”, // Channel capability
                  “command”: “setTvChannel”, // changing a channel
                  “arguments”: [ // Defining a channel number
                    {
                      “dataType”: “datatype. schema. AFCommandArgument”,
                      “dataValue”: {
                        “name”: “tvChannel”,
                        “optional”: false,
                        “dataType”: “datatype .primitive. AFString”
                      }
                    }
                  ]
                }
              }
            },
            “styles”: {
              “x”: 1180,
              “y”: 336.640625
            }
          },
          {
            “nodeId”: “d02fcd27-c178-4ff6-8a6a-b43ecdf5d157”,
            “nodeVer”: “1.0”,
            “nodeType”: “capabilityCommand”, // As previously described, a
node that performs a function of sending a device control command. In the
corresponding graph, node “capabilityCommand” has used twice, one for
turning on TV power and the other for changing the channel to “11”.
                          // Other commands may be executed simply
by changing an input or configuration of a node called “capabilityCommand”.
            “isStateful”: true,
            “isTriggerOnChange”: false,
            “group”: null,
            “inputPorts”: { }, // A power switch operation does not have a
separate input.
            “triggerPorts”: {
              “success”: {
                “nodes”: [
                  “c6030f81 -127a-4340-a70c-49c42cf2dc5c”
                ]
              },
              “failure”: {
                “nodes”: [ ]
              }
            },
            “configurations”: {
              “command”: {
                “dataType”: “datatype.schema.AFCapabilityCommand”,
                  “dataValue”: {
                    “component”: “main”,
                    “capability”: “switch”,
                    “command”: “on”, // Setting channel “on” command to be
executed.
                    “arguments”: [ ]
                  }
                }
              }
              “styles”: {
                “x”: 920,
                “y”: 156.640625
              }
            },
            {
              “nodeId”: “8b0e703d-94b1-4fc2-8dbd-6e5bd8bfe475”,
              “nodeVer”: “1.0”,
              “nodeType”: “response”, // A node that sends a voice response to
a user.
              “isStateful”: true,
              “isTriggerOnChange”: false,
              “group”: null,
              “inputPorts”: {
                “Channel”: {
                  “nodes”: [
                    “4ef5e297-f6al-436d-b977-cb8b0238051c” // A result value
of a “parameter” node is used as a channel number. “Yes, I'll play
#{Channel}” defined below.
                                        // A resulting value of a “parameter”
node instead of #{Channel} in a voice response. That is, “Yes, play 11 by
using “11” is executed.
                  ],
                  “portinfo”: { // Defines data types capable of being used for
#{ Channel}.
                  “dataTypes”: [
                  “datatype.util.AFList”,
                    “datatype.primitive.AFString”,
                    “datatype.primitive.AFInteger”,
                    “datatype.primitive.AFNumber”,
                    “datatype, primitive. AFBoolean″,
                    “datatype.primitive.AFTime”,
                          “datatype.smartthings.AFVocab”,
                          “datatype.smartthings.AFNumberVocab”
                        ],
                        “minitems”: 0,
                        “maxitems”: 1
                      }
                    }
                  },
                  “triggerPorts”: {
                    “main”: {
                      “nodes”: [ ]
                    }
                  }
                  “configurations”: {
                    “handsOnDialogue”: { // handsFreeDialogue(Response for a
speaker), handsOnDialogue(Response for a mobile device)
                      “dataType”: “datatype.schema.AFDialogue”,
                      “dataValue”: {
                        “parameters”: {
                          “Channel”: {
                          “dataType”: “datatype. schema. AFDialogueParameter”,
                          “dataValue”: {
                            “type”: “string”,
                          }
                        }
                      },
                      “dialogueld”:
“Rev_SamsungIoT_13_42_SetValue_LiveTVOrSTB_YesOrNo_Yes”, //
Below is an example of “Yes, play #{Channel}.”
                                            tvChannel // Actually, value
Rev_SamsungIoT_13_42_SetValue_LiveTVOrSTB_YesOrNo_Yes and the
above value “11” return to a voice recognition server,
// A speech recognition server induces natural language processing by using
Rev_SamsungIoT_l 3_42_SetV alue_LiveTV OrSTB_YesOrNo_Y es
Response.
                      “template”: “Yes, play #{ Channel}.” // This is an example of
a voice response and indicates that a parameter value corresponding to
#{Channel} is required.
                    }
                  }
                },
                “styles”: {
                  “x”: 1475,
                  “y”: 500
                }
              },
              {
                “nodeld”: “4ef5e297-f6a1-436d-b977-cb8b023805 1c”,
                “nodeVer”: “1.0”,
                “nodeType”: “parameter”, // Storing a parameter value included
in a user voice command. Here, “11” is stored.
                “isStateful”: true,
                “isTriggerOnChange”: false,
                “group”: null,
                “inputPorts”: { },
                “triggerPorts”: { },
                  “configurations”: {
                    “key”: {
                      “dataType”: “datatype.primitive.AFString”,  //  “11” is
expressed as a string data type.
                      “dataValue”: “string”// Parameter Key Name
                    }
                  },
                  “styles”: {
                    “x”: 0,
                    “y”: Oc apability Command
                  }
                }
              ]
            }
          },
          “href’: “/capability/tvChannel/main/0” // A role finally performed by
the corresponding voice metadata is expressed as an loT specification. // For
example, the corresponding voice metadata has written to do the task of
changing a channel on TV, and thus “component”: “main”, “capability”:
“tvChannel” in a configuration of the “capabilityCommand” node are
expressed and stored depending on an loT specification. // This value is used
to determine voice metadata executed by an execution engine when a user
utterance is executed.
        }
      ]
    }
  ]
}
```

According to an embodiment, the voice metadata execution engine 810 may include a voice metadata loader 811, a voice metadata parser 813, an execution decision module 815, and/or a command sender 817.

According to an embodiment, the voice metadata loader 811 may recognize the corresponding voice metadata based on information 801 (e.g., information (e.g., the type of a target device, the vendor ID of the target device) of a target device (e.g., the target device 640 in FIG. 6) and/or user intent) received from an external electronic device (e.g., a user terminal (e.g., the electronic device 101 of FIG. 1, the user terminal 201 of FIGS. 2 to 4, or the external electronic device 610 of FIG. 6)) or a speech recognition module (e.g., the speech recognition module 621 of FIG. 6). For example, the voice metadata loader 811 may search for and obtain (803) the voice metadata, which corresponds to information of the target device, from among the voice metadata stored in the voice metadata module (e.g., the voice metadata storage 6253 of FIG. 6). According to an embodiment, the voice metadata loader 811 may transmit a request for voice metadata corresponding to information of a device to a voice metadata module in a form of a representational state transfer (REST) API and may download the voice metadata corresponding to the request from the voice metadata module. According to an embodiment, the voice metadata obtained by the voice metadata loader 811 may be stored in a memory of the intent handler module 800 in a form (e.g., JSON file) of an object According to an embodiment, the voice metadata stored in the form of an object may be accessed by other components included in the voice metadata execution engine 810.

According to an embodiment, the voice metadata parser 813 may divide the voice metadata into a plurality of objects. For example, the voice metadata parser 813 may divide the voice metadata stored as one object into the plurality of objects (e.g., nodes), each of which has a smaller unit. According to an embodiment, a node may mean the minimum execution unit of voice metadata. For example, when the voice metadata includes one JSON file, the node may mean a JSON block that is the minimum execution unit of the voice metadata. According to an embodiment, the voice metadata parser 813 may rearrange nodes obtained by dividing the voice metadata depending on an execution order. For example, the voice metadata parser 813 may rearrange nodes based on the execution order (e.g., information of a node to be executed after the corresponding node) included in each of the nodes of the voice metadata.

According to an embodiment, the execution decision module 815 may execute each of the rearranged nodes (i.e., rearranged JSON blocks) of the voice metadata in order. For example, the execution decision module 815 may determine whether to execute each of the nodes, based on the content of each of the rearranged nodes. For example, the execution decision module 815 may execute a node corresponding to an action corresponding to the user's voice input (or user intent) or may execute a node corresponding to an action that is a precondition for performing an action corresponding to a voice input (or user intent). According to an embodiment, as nodes are sequentially executed, the execution decision module 815 may determine whether a precondition for performing an action corresponding to the user's voice input (or user intent) is satisfied, and may determine a node to be executed next based on the determined result.

According to an embodiment, the command sender 817 may transmit a command for controlling the target device to the target device. For example, the command sender 817 may transmit a command to the target device through a cloud server (e.g., an IoT cloud server) connected to the target device. For example, the command sender 817 may extract a command from a node including a command for controlling the target device, and may transmit the extracted command to the target device. According to an embodiment, the command sender 817 may generate or convert a command in a form of REST APIs based on a node including the command for controlling the target device. The command sender 817 may deliver the command for controlling the target device by calling the cloud server connected to the target device. According to an embodiment, the command sender 817 may transmit, to the target device, a command 805 corresponding to an action corresponding to a precondition for performing an action corresponding to the user's voice input and/or a command 807 corresponding to an action corresponding to the user's voice input.

According to various embodiments, a configuration of the voice metadata execution engine 810 is not limited to that shown in FIG. 8. At least one of the voice metadata loader 811, the voice metadata parser 813, the execution decision module 815, and the command sender 817 may be implemented as one module and may include an additional configuration. Alternatively, some configurations thereof may be omitted.

According to an embodiment of the disclosure, an electronic device (e.g., the electronic device 101 or the server 108 of FIG. 1, the intelligence server 300 and/or the service server 400 of FIG. 2, the electronic device 500 of FIG. 5, or the electronic device 620 of FIG. 6) may include a communication circuit (e.g., the communication module 190 of FIG. 1 or the communication circuit 510 of FIG. 5), a memory (e.g., the memory 130 of FIG. 1 or the memory 520 of FIG. 5) and a processor (e.g., the processor 120 of FIG. 1 or the processor 530 of FIG. 5) operatively connected to the communication circuit and the memory. The memory may store instructions that, when executed, cause the processor to receive a voice input of a user from an external electronic device (e.g., a user terminal (e.g., the electronic device 101 of FIG. 1, the user terminal 201 of FIGS. 2 to 4, or the external electronic device 610 of FIG. 6)) by using the communication circuit, to recognize voice metadata associated with the voice input based on the voice input, to determine, based on the voice metadata, whether a precondition to perform an action corresponding to the voice input is present, responsive to determining that the precondition is present, to transmit a first command for performing an action corresponding to the precondition based on the voice metadata to a target device (e.g., the target device 640 of FIG. 6) by using the communication circuit, and to transmit a second command for performing the action corresponding to the voice input to the target device by using the communication circuit.

According to an embodiment, the instructions may, when executed, cause the processor to cause the target device to provide the external electronic device with a result of performing the action corresponding to the voice input.

According to an embodiment, the instructions may, when executed, cause the processor to recognize a user intent and a target device, which will perform the action corresponding to the voice input, based on the voice input of the user and to recognize the voice metadata based on the user intent and information associated with the target device.

According to an embodiment, the information associated with the target device may include at least one of vendor identification (VID) of the target device, a type of the target device, or manufacturer information of the target device.

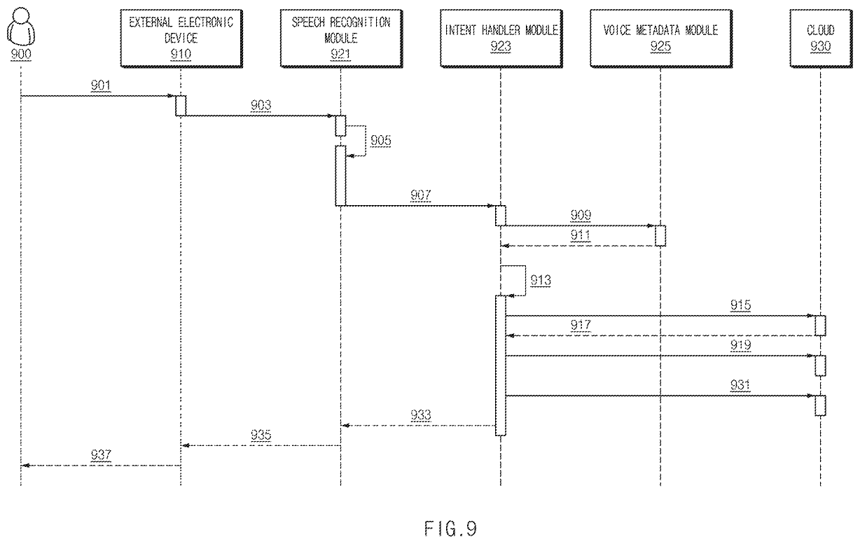

According to an embodiment, the instructions may, when executed, cause the processor to transmit the first command for performing the action corresponding to the precondition and the second command for performing the action corresponding to the voice input to the target device through the electronic device and a cloud server (e.g., the server 108 of FIG. 1, the cloud 630 of FIG. 6, or the cloud 930 of FIG. 9) connected to the target device.

According to an embodiment, the instructions may, when executed, cause the processor, to identify a state of the target device associated with the precondition responsive to determining that the precondition is present, and to transmit the command for performing the action corresponding to the precondition based on the voice metadata to the target device responsive to determining that the state of the target device does not satisfy the precondition.

According to an embodiment, the user intent may include at least one of voice capability information, voice action information, and parameter information, which are associated with the action corresponding to the voice input.

According to an embodiment, the voice metadata may be stored in advance in a memory of the external electronic device connected to the electronic device and may be stored.

FIG. 9 is a flowchart illustrating an operation of an artificial intelligence assistant system, according to an embodiment. According to an embodiment, an artificial intelligence assistant system (e.g., the integrated intelligence system of FIG. 2, the artificial intelligence assistant system 600 of FIG. 6) may include an external electronic device 910 (e.g., the electronic device 101 of FIG. 1 or the user terminal 201 of FIGS. 2 to 4), an electronic device (e.g., the electronic device 101 of FIG. 1 and/or the server 108, the intelligence server 300 and/or the service server 400 of FIG. 2, the electronic device 500 of FIG. 5, or the electronic device 620 of FIG. 6), a cloud server 930 (e.g., the cloud server 630 of FIG. 6), and/or a target device (not illustrated) (e.g., the target device 640 of FIG. 6). According to an embodiment, the electronic device may include a speech recognition module 921 (e.g., the speech recognition module 621 of FIG. 6), an intent handler module 923 (e.g., the intent handler module 623 of FIG. 6, the intent handler module 723 of FIG. 7, or the intent handler module 800 of FIG. 8), and a voice metadata module 925 (e.g., the voice metadata module 625 of FIG. 6). According to an embodiment, the speech recognition module 921, the intent handler module 923, and/or the voice metadata module 925 may be implemented as an independent server. According to an embodiment, the cloud server (cloud) 930 may be an IoT server that manages a plurality of devices.

According to an embodiment, in operation 901, the external electronic device 910 (e.g., a user terminal (e.g., the electronic device 101 of FIG. 1, the user terminal 201 of FIGS. 2 to 4, or the external electronic device 610 of FIG. 6)) may receive a voice input from a user 900. For example, the external electronic device 910 may receive the voice input uttered by the user 900 through a microphone. According to an embodiment, the external electronic device 910 may convert the voice received from the user 900 into voice data. For example, the external electronic device 910 may receive the voice input of “change TV channel to No. 11” from the user 900.

According to an embodiment, in operation 903, the external electronic device 910 may transmit the voice input to the speech recognition module 921. According to an embodiment, the external electronic device 910 may transmit voice data corresponding to the voice input received from the user 900 to the speech recognition module 921. For example, the external electronic device 910 may transmit the voice input (data corresponding to a voice input) of “change TV channel to No. 11” to the speech recognition module 921.

According to an embodiment, in operation 905, the speech recognition module 921 may perform NLU processing on the voice input of the user 900. For example, the speech recognition module 921 may recognize target device-related information (e.g., the type of a target device) and/or intent of the user 900 based on the voice input of the user 900. For example, the speech recognition module 921 may extract the target device-related information and/or the intent of the user 900 from the voice input of the user 900. For example, the speech recognition module 921 may recognize ‘TV’, which is the type of the target device, and the intent of the user 900 of “change a channel to No. 11 (e.g., channel-set, 11),” based on the input of the user 900 of “change TV channel to No. 11.”

According to an embodiment, in operation 907, the speech recognition module 921 may transmit the recognized target device-related information and the recognized intent of the user 900 to the intent handler module 923.

According to an embodiment, in operation 909, the intent handler module 923 may request voice metadata corresponding to the voice metadata module 925 based on the target device-related information and the intent of the user 900. For example, the intent handler module 923 may request the voice metadata module 925 to search for and transmit voice metadata corresponding to the intent of the user 900 and the target device-related information among voice metadata stored in the voice metadata module 925. According to an embodiment, when recognizing the type (kind) of the target device, the intent handler module 923 may recognize the target device corresponding to the voice input based on information (e.g., a user's account information) of the user uttering a voice input (voice command) and/or information of an external electronic device (e.g., a user terminal). According to an embodiment, the intent handler module 923 may obtain the corresponding voice metadata based on the recognized target device and/or the recognized user intent.

According to an embodiment, in operation 911, the voice metadata module 925 may provide the intent handler module 923 with voice metadata corresponding to the target device-related information and the intent of the user 900. For example, the intent handler module 923 may download the voice metadata corresponding to the target device-related information and the user intent from the voice metadata module 925. According to an embodiment, the voice metadata module 925 may store at least one voice metadata corresponding to various devices and functions in advance. For example, the voice metadata module 925 may receive and store predetermined voice metadata from a developer (manufacturer) of a device. According to an embodiment, the voice metadata may be implemented as an execution file (e.g., JSON file) in a specified format capable of being executed by the intent handler module 923.

According to an embodiment, in operation 913, the intent handler module 923 may execute the voice metadata obtained from the voice metadata module 925.

According to an embodiment, the intent handler module 923 may perform a series of operations (operation 915 to operation 931) for performing an action corresponding to the voice input of the user 900 based on the obtained voice metadata.

According to an embodiment, in operation 915, the intent handler module 923 may determine whether there is a precondition for performing an action (e.g., ‘change TV channel to No. 11’) corresponding to a voice input of the user 900 based on the voice metadata. For example, the intent handler module 923 may recognize the precondition (e.g., ‘a state where a TV is powered on’) for changing TV channel to No. 11. According to an embodiment, the intent handler module 923 may determine whether the precondition is satisfied. According to an embodiment, in operation 915, the intent handler module 923 may make a request for the state information of the target device to the cloud server 930 connected to the target device. For example, the intent handler module 923 may make a request for information about “a power state of TV” to the cloud server 930.

According to an embodiment, in operation 917, the cloud server 930 may provide the state information of the target device to the intent handler module 923. For example, the cloud server 930 may provide the intent handler module 923 with information indicating that “the TV is powered off.”

According to an embodiment, in operation 919, the intent handler module 923 may transmit, to the cloud server 930, a command for performing an action corresponding to the precondition for performing the voice input of the user 900 based on the state information of the target device. For example, when the intent handler module 923 recognizes that the TV is powered off, the intent handler module 923 may transmit, to the cloud server 930, a command for performing an action (e.g., turning on the TV) corresponding to the precondition before performing the action corresponding to the voice input of the user 900 of “change TV channel to No. 11.” According to an embodiment, the cloud server 930 may transmit the command received from the intent handler module 923 to the target device (e.g., the TV). The target device may perform an action (e.g., an action of turning on the TV) corresponding to the received command. According to an embodiment, when there is no precondition for performing the voice input of the user 900 (e.g., when the voice input of the user 900 does not indicate another precondition such as “turn on the TV”), or when the precondition for performing the voice input of the user 900 is already satisfied (e.g., the TV is already turned on), the intent handler module 923 may omit operation 919.

According to an embodiment, in operation 931, the intent handler module 923 may transmit, to the cloud server 930, a command for performing an action corresponding to the voice input of the user 900. For example, the intent handler module 923 may transmit, to the cloud server 930, a command for changing the TV channel to No. 11. According to an embodiment, the cloud server 930 may transmit the command received from the intent handler module 923 to the target device. The target device may perform an action (e.g., change the TV channel to No. 11) corresponding to the received command. According to various embodiments, in operation 919 and operation 931, it is illustrated that the cloud server 930 receives a command from the intent handler module 923. However, the intent handler module 923 may also directly transmit a command to the target device without going through the cloud server 930.

According to various embodiments, operation 915 to operation 931 are operations based on voice metadata, and execution order and execution operations may be changed. For example, the order and content of operation 915 to operation 931 may be changed depending on voice metadata executed by the intent handler module 923 in operation 913.

According to an embodiment, in operation 933, the intent handler module 923 may transmit a result of performing the action corresponding to the voice input of the user 900 to the speech recognition module 921. For example, the intent handler module 923 may transmit, to the speech recognition module 921, a response indicating whether the action corresponding to the voice input has succeeded or failed. For example, the intent handler module 923 may provide a response indicating that “a channel change has succeeded” to the speech recognition module 921.

According to an embodiment, in operation 935, the speech recognition module 921 may deliver, to the external electronic device 910, a result of performing the action corresponding to the voice input of the user 900. For example, the speech recognition module 921 may transmit, to the external electronic device 910, a response indicating whether the action corresponding to the voice input has succeeded or failed. For example, the speech recognition module 921 may transmit a response indicating “a channel change has succeeded” to the external electronic device 910. According to an embodiment, the result of the action corresponding to the voice input of the user 900 may be directly transmitted from the intent handler module 923 to the external electronic device 910 without going through the speech recognition module 921.

According to an embodiment, in operation 937, the external electronic device 910 may provide the user 900 with a result of performing the action corresponding to the voice input of the user 900. For example, the external electronic device 910 may provide the result of performing the action visually and/or audibly. For example, the external electronic device 910 may display the result of performing the action corresponding to the voice input through a display or may output the result of performing the action corresponding to the voice input through a speaker. For example, the external electronic device 910 may provide the user 900 with a result of performing an action such as “a channel has been normally changed.”

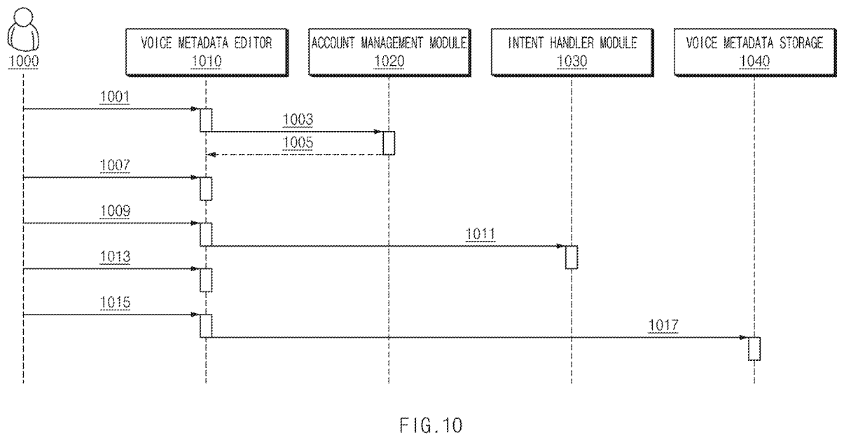

FIG. 10 is a flowchart illustrating an operation of registering voice metadata in a voice metadata module (e.g., a voice metadata storage 1040), according to an embodiment.

According to an embodiment, a voice metadata module (e.g., the voice metadata module 625 of FIG. 6 or the voice metadata module 925 of FIG. 9) may include a voice metadata editor 1010 (e.g., the voice metadata editor 6251 of FIG. 6) and a voice metadata storage 1040 (e.g., the voice metadata storage 6253 of FIG. 6). According to an embodiment, the voice metadata editor 1010 may include various user interfaces (e.g., an Internet site, an application, a program, and/or a voice metadata editing tool) provided by the voice metadata module.

According to an embodiment, in operation 1001, a user 1000 (e.g., a device developer) may access the voice metadata editor 1010. For example, the user 1000 may access an interface (e.g., a site of the voice metadata editor 1010) of the user 1000 related to the voice metadata editor 1010.

According to an embodiment, in operation 1003, the voice metadata editor 1010 may access an account management module 1020. According to an embodiment, the account management module 1020 may be a server that manages an account for managing IoT devices of the user 1000. For example, the voice metadata editor 1010 may log in to an account of the user 1000 registered in the account management module 1020. For example, the voice metadata editor 1010 may transmit user information (e.g., user account information) received from the user 1000 to the account management module 1020.

According to an embodiment, in operation 1005, the account management module 1020 may authenticate the account of the user 1000 based on the received user information. According to an embodiment, when the account of the user 1000 is authenticated, the account management module 1020 may transmit an authentication token (e.g., an IoT scope authentication token) to the voice metadata editor 1010. According to an embodiment, the authentication token may be used to grant authority to allow the account of the user 1000 to control the related IoT device. For example, when the user 1000 is authorized by the authentication token, the user 1000 may execute and test voice metadata through a device (e.g., an IoT device) owned by the user 1000 or a test device during writing the voice metadata.

According to an embodiment, in operation 1007, the voice metadata editor 1010 may receive device information (e.g., the vendor ID of a device) from the user 1000.

According to an embodiment, in operation 1009, the user 1000 may make a request for a list of user intent for creating voice metadata to the voice metadata editor 1010. According to an embodiment, the user intent list may include information of at least one user intent available for each device. According to an embodiment, the user intent list may be different depending on device information (e.g., the vendor ID of the device).

According to an embodiment, in operation 1011, the voice metadata editor 1010 may make a request for a list of user intent to the intent handler module 1030 (e.g., the intent handler module 623 of FIG. 6, the intent handler module 723 of FIG. 7, the intent handler module 800 of FIG. 8, or the intent handler module 923 of FIG. 9). For example, the voice metadata editor 1010 may transmit a request for the user intent list together with the device information to the intent handler module 1030. According to an embodiment, the intent handler module 1030 may store information about pieces of user intent available for each device in advance. According to an embodiment, the intent handler module 1030 may provide the voice metadata editor 1010 with the user intent list corresponding to the device information in response to the request.

According to an embodiment, in operation 1013, the voice metadata editor 1010 may receive an input for selecting specified user intent from the user 1000. For example, the voice metadata editor 1010 may receive the input for selecting the specified user intent from the user intent list from the user 1000.

According to an embodiment, in operation 1015, the voice metadata editor 1010 may generate voice metadata based on a user input. For example, the voice metadata editor 1010 may generate voice metadata including the content of at least one user intent selected by the user 1000. According to an embodiment, the voice metadata may be generated as a file in a specified format (e.g., JSON).

According to an embodiment, in operation 1017, the voice metadata editor 1010 may store the generated voice metadata in the voice metadata storage 1040.

According to various embodiments, at least part of a voice metadata module (e.g., the voice metadata module 1010 and/or the voice metadata storage 1040), the account management module 1020, and the intent handler module 1030 may be implemented as an integrated server. Each of the voice metadata module, the account management module 1020, and the intent handler module 1030 may be implemented as a separate server or interface.

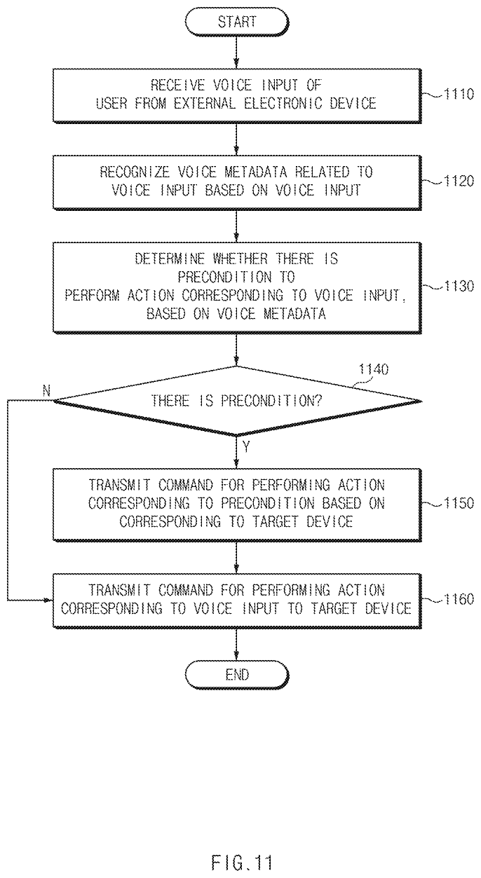

FIG. 11 is a flowchart of a method of operating an electronic device, according to an embodiment.

According to an embodiment, in operation 1110, an electronic device (e.g., the electronic device 101 or the server 108 of FIG. 1, the intelligence server 300 and/or the service server 400 of FIG. 2, the electronic device 500 of FIG. 5, or the electronic device 620 of FIG. 6) may receive a user's voice input from an external electronic device (e.g., a user terminal (e.g., the electronic device 101 of FIG. 1, the user terminal 201 of FIGS. 2 to 4, the external electronic device 610 of FIG. 6, or the external electronic device 910 of FIG. 9). According to an embodiment, the electronic device may recognize user intent by performing NLU processing on the voice input.

According to an embodiment, in operation 1120, the electronic device may recognize voice metadata related to the voice input based on the voice input. According to an embodiment, the electronic device may recognize voice metadata related to the voice input based on information (e.g., the type of the target device or the vendor ID of the target device) of the target device (e.g., the target device 640 of FIG. 6) and/or the user intent.

According to an embodiment, in operation 1130, the electronic device may determine whether there is a precondition to perform an action corresponding to a voice input, based on the voice metadata. For example, when the user's voice input is “change TV channel to No. 10,” a precondition for turning on the TV may be performed prior to performing an “action for changing the TV channel to No. 10” corresponding to the user's voice input. As another example, when the user's voice input is “lower a temperature of an air conditioner to 18 degrees,” a precondition for turning on the air conditioner may be performed prior to performing an action of “lowering the temperature of the air conditioner by 18 degrees” corresponding to the user's voice input.

According to an embodiment, in operation 1140, the electronic device performs operation 1150 responsive to determining that there is a precondition (operation 1140? ‘Yes’), or the electronic device may perform operation 1160 responsive to determining that there is no precondition (operation 1140? ‘No’).

According to an embodiment, in operation 1150, the electronic device may transmit a command for performing an action corresponding to the precondition based on voice metadata to a target device. According to an embodiment, the target device may include an IoT device connected to a cloud server. According to an embodiment, the electronic device may transmit a command for allowing the target device to perform the action corresponding to the precondition to the cloud server (e.g., the cloud server 630 of FIG. 6 or the cloud server 930 of FIG. 9). The cloud server may deliver the command for performing the action corresponding to the precondition to the target device. According to an embodiment, responsive to determining that there is no precondition for performing the voice input of a user, or responsive to determining that the precondition for performing the voice input of the user is already satisfied, the electronic device may omit operation 1150.

According to an embodiment, in operation 1160, the electronic device may transmit a command for performing an action corresponding to the voice input to the target device. According to an embodiment, the electronic device may transmit a command, which provides for the target device to perform an action corresponding to the voice input, to the cloud server. The cloud server may deliver the command for performing the action corresponding to the voice input to the target device.

According to an embodiment, responsive to the target device performing an action (e.g., an action corresponding to a precondition and/or an action corresponding to a voice input) corresponding to the command, the electronic device may provide the action execution result to the external electronic device. For example, the electronic device may provide the external electronic device with the response indicating the result of performing the action of the target device.

According to an embodiment of the disclosure, when it is desired to perform an action corresponding to a precondition to perform an action corresponding to a user's voice input, it is possible to perform an action corresponding to the voice input after performing a condition corresponding to the precondition without an additional input of a user, thereby smoothly providing a service matching the user's intent.

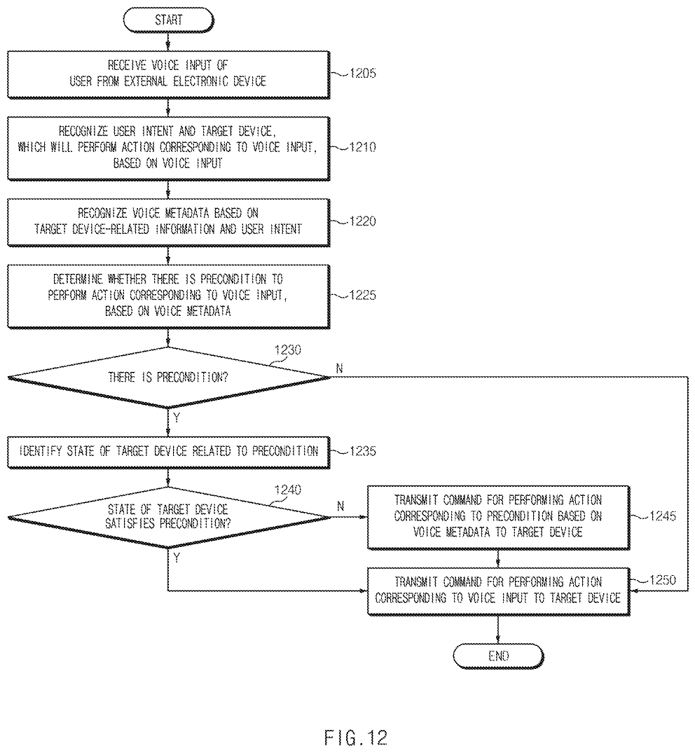

FIG. 12 is a flowchart of an operating method of an electronic device, according to an embodiment. Hereinafter, one or more portions the same as that described with reference to FIG. 11 are omitted or are briefly described.

According to an embodiment, in operation 1205, an electronic device (e.g., the electronic device 101 or the server 108 of FIG. 1, the intelligence server 300 and/or the service server 400 of FIG. 2, the electronic device 500 of FIG. 5, or the electronic device 620 of FIG. 6) may receive a user's voice input from an external electronic device (e.g., a user terminal (e.g., the electronic device 101 of FIG. 1, the user terminal 201 of FIGS. 2 to 4, the external electronic device 610 of FIG. 6, or the external electronic device 910 of FIG. 9).

According to an embodiment, in operation 1210, the electronic device may recognize user intent and information (e.g., an ID of a target device, a name of a target device, and/or the type of a target device) about a target device, which will perform an action corresponding to a voice input, based on the voice input. For example, the electronic device may recognize the target device-related information and/or the user intent by performing NLU processing on the voice input.

According to an embodiment, in operation 1220, the electronic device may recognize voice metadata based on the target device-related information and/or the user intent. For example, the electronic device may recognize voice metadata corresponding to the user's voice input.

According to an embodiment, in operation 1225, the electronic device may determine whether there is a precondition to perform an action corresponding to a voice input, based on the voice metadata. For example, when the user's voice input is “change TV channel to No. 12,” a precondition for turning on the TV may be performed prior to performing an “action for changing the TV channel to No. 12” corresponding to the user's voice input.

According to an embodiment, in operation 1230, the electronic device performs operation 1235 when there is a precondition (operation 1230? ‘Yes’), or the electronic device may perform operation 1250 when there is no precondition (operation 1230? ‘No’).

According to an embodiment, in operation 1235, the electronic device may identify a state of the target device related to the precondition. For example, the electronic device may make a request for state information related to the precondition to the target device and may receive the state information from the target device. For example, the electronic device may obtain the state information of the target device through the cloud server connected to the target device. For example, the electronic device may obtain information about a power state of the target device from the target device (e.g., TV) with regard to the precondition (e.g., ‘a state where a TV is powered on’) for changing TV channel to No. 12. For example, the electronic device may obtain state information indicating whether the target device is powered on or off.

According to an embodiment, in operation 1240, the electronic device may determine whether the state of the target device satisfies the precondition. According to an embodiment, the electronic device may perform operation 1245 when the state of the target device does not satisfy the precondition (operation 1240? ‘No’), and may perform operation 1250 when the state of the target device satisfies the precondition (action 1240? ‘Yes’). For example, when recognizing that the TV is turned off, based on the state information of the target device (e.g., TV), the electronic device may perform operation 1245 by determining that the precondition is not satisfied. When recognizing that the TV is powered on, based on the state information of the target device (e.g., TV), the electronic device may perform operation 1250 by determining that the precondition is satisfied.

According to an embodiment, in operation 1245, the electronic device may transmit a command for performing an action corresponding to the precondition based on voice metadata to a target device. According to an embodiment, the target device may include an IoT device connected to a cloud server. According to an embodiment, the electronic device may transmit a command that causes the target device to perform the action corresponding to the precondition to the cloud server (e.g., the cloud server 630 of FIG. 6 or the cloud server 930 of FIG. 9). The cloud server may deliver the command for performing the action corresponding to the precondition to the target device.

According to an embodiment, in operation 1250, the electronic device may transmit a command for performing an action corresponding to the voice input to the target device. According to an embodiment, the electronic device may transmit a command, which causes the target device to perform an action corresponding to the voice input, to the cloud server. The cloud server may deliver the command for performing the action corresponding to the voice input to the target device.

According to an embodiment, when the target device performs an action (e.g., an action corresponding to a precondition and/or an action corresponding to a voice input) corresponding to the command, the electronic device may provide the action execution result to the external electronic device. For example, the electronic device may provide the external electronic device with the response indicating the result of performing the action of the target device.

According to an embodiment of the disclosure, when it is desired to perform an action corresponding to a precondition to perform an action corresponding to a user's voice input, it is possible to perform an action corresponding to the voice input after performing a condition corresponding to the precondition without an additional input of a user, thereby smoothly providing a service matching the user's intent.

FIGS. 13A to 13G are examples of a user interface for generating voice metadata, according to an embodiment. According to an embodiment, a user interface may include a voice metadata editor (e.g., the voice metadata editor 6251 of FIG. 6 or the voice metadata editor 1010 of FIG. 10). According to an embodiment, a user interface for generating voice metadata may include at least one of a program, an application, and a website that are capable of generating and/or editing the voice metadata.

According to an embodiment, FIG. 13A shows an example of a voice metadata editing screen 1300. According to an embodiment, the voice metadata editing screen 1300 may include an area 1310 for providing voice metadata information, an area 1320 for providing voice capability information, an area 1330 for providing nodes used to form voice metadata, and/or an area 1340 displaying a graph having nodes.

Referring to FIG. 13B, the area 1310 for providing the voice metadata information may include a device name 1311 corresponding to voice metadata, device manufacturer information 1312, a device nickname 1313, a device (voice metadata) version 1314, a device VID 1315, and/or information of a device type 1316.

Referring to FIG. 13C, the user interface may provide an available voice capability list 1321. For example, the user interface may provide the voice capability list 1321 available in the corresponding device based on device information corresponding to voice metadata being edited. According to an embodiment, the user interface may provide the voice capability list 1321 through the area 1320 providing voice capability information. According to an embodiment, user intent may include voice capability and voice action. For example, a user may select voice capability corresponding to the user intent to be used in voice metadata being edited from the voice capability list 1321. For example, FIG. 13C shows that a ‘channel’ is selected from the voice capability list 1321.

Referring to FIG. 13D, when the user selects voice capability, the user interface may provide a voice action list 1323 related to the selected voice capability. According to an embodiment, the voice action list 1323 may include a selection box 1325, a voice action name 1326, an enumeration 1327, a data transmission method 1328, and/or a description 1329. For example, a user may select a voice action corresponding to the user intent to be used in voice metadata being edited from the voice action list 1321. For example, FIG. 13D shows that ‘set’ is selected from the voice action list 1323. For example, referring to FIGS. 13C and 13D, ‘Channel-Set’ may be selected as user intent to be used in voice metadata depending on a user input.

Referring to FIG. 13E, the user interface may provide a screen 1350 for writing preconditions and device control logic based on the set (selected) voice intent. For example, a user interface (e.g., a voice metadata editor) may support drag-and-drop editing based on a node graph. According to an embodiment, a node may be the smallest logical unit constituting voice metadata. For example, the node may be the smallest logical unit associated with performing a function. For example, the screen 1350 may include a list 1351 of available nodes, an area 1353 for displaying a graph having nodes, and/or an area 1355 for displaying node information. For example, the area 1355 for displaying the node information may include information about at least one of an attribute, a component, a capability, a property, and a value type of a node.

Hereinafter, an example of generating a graph will be described with reference to FIGS. 13F and 13G. For example, FIGS. 13F and 13G show graphs including branches (e.g., dotted-line routes 1371 and 1375 and solid-line routes 1373 and 1377). For example, in FIGS. 13F and 13G, the dotted-line routes 1371 and 1375 indicate routes on which a node is executed based on a device state. The solid-line routes 1373 and 1377 indicate routes on which a node is not executed.

For example, a first node 1361 is a start node, and may be configured to correspond to the user's voice input “set a channel to No. 11.”

For example, a second node 1362 is a node configured to perform a function of returning to the state of a device, and may be configured to return to, for example, the power state of the TV. For example, when the TV is powered on, the second node 1362 may be configured to return to an ‘on’ value. When the TV is powered off, the second node 1362 may be configured to return to an ‘off’ value.

For example, a seventh node 1367 may be a node at which a constant value for comparing a return value of the second node is set. For example, it is assumed that the seventh node 1367 is set to the ‘on’ value as the constant value.

For example, a third node 1363 may be a node for comparing values, and may be configured to compare a value of the second node 1362 with a value of the seventh node 1367. For example, the third node 1363 may be configured to select a node to be executed next depending on the result of comparing the value of the second node 1362 with the value of the seventh node 1367. For example, the third node 1363 may be a node that determines a branch. For example, when the value of the second node 1362 is the same as the value of the seventh node 1367, the third node 1363 may return to a value of ‘true.’ When the value of the second node 1362 is different from the value of the seventh node 1367, the third node 1363 may return to a value of ‘false.’ For example, the seventh node 1367 may have a constant value indicating ‘on.’ Accordingly, when the value of ‘true’ is returned, it may indicate that the TV is powered on. When the value of ‘false’ is returned, it may indicate that the TV is powered off. For example, when the value of ‘false’ is returned at the third node 1363, a function of a fourth node 1364 may be executed. When a value of ‘true’ is returned at the third node 1363, a function of a fifth node 1365 may be executed. For example, the third node 1363 may be configured to determine whether state information of a device satisfies a precondition for performing an action corresponding to the user's voice input.

For example, the fourth node 1364 may be a node configured to perform an operation of the device, and may be configured to perform, for example, an action of turning on TV. For example, when voice metadata is executed at runtime by an intent handler module (e.g., a voice metadata execution engine) at the fourth node 1364, the intent handler module (e.g., a voice metadata execution engine) may be configured to transmit a command for performing an action of turning on TV to a target device (TV) (e.g., the target device 640 of FIG. 6). For example, when there is a precondition for performing an action corresponding to a user's voice command, and the state of a device does not satisfy the precondition, the fourth node 1364 may be a node configured to first perform an action corresponding to the precondition.

For example, the fifth node 1365 may be node configured to perform an operation of the device, and may be configured to perform, for example, an action of changing TV channel. For example, when voice metadata is executed at runtime by the intent handler module (e.g., the intent handler module 623 of FIG. 6, the intent handler module 723 of FIG. 7, the intent handler module 800 of FIG. 8, the intent handler module 923 of FIG. 9, or the intent handler module 1030 of FIG. 10) (e.g., a voice metadata execution engine (e.g., the voice metadata execution engine 6231 of FIG. 6 or the voice metadata execution engine 810 of FIG. 8) at the fifth node 1365, an intent handler module (e.g., a voice metadata execution engine) may be configured to transmit a command for performing an action of changing TV channel to the target device (TV). For example, when a parameter value is used to perform an operation of the device in relation to the fifth node 1365, an eighth node 1368 may be a node configured to indicate a parameter value. For example, the eighth node 1368 may be configured to return to a parameter value of ‘11’ based on the user's voice input.

For example, a sixth node 1366 may indicate a node configured to provide a result of performing an operation of the device. For example, when the corresponding node is executed at the sixth node 1366, an intent handler module (e.g., a voice metadata execution engine) may be configured to provide a voice response such as “Yes, I'll change a channel to No. 11.”

For example, FIG. 13F shows a node graph configured to first perform an action (turning on TV) corresponding to a precondition before an action (changing TV channel to No. 11) corresponding to a voice input is performed after a node is executed along the dotted-line route 1371 when the TV is turned off. FIG. 13G shows a node graph configured to perform an action (changing TV channel to No. 11) corresponding to a voice command at once without performing an action (turning on TV) corresponding to the precondition after a node is executed along the dotted-line route 1375 when the TV is turned on.

According to an embodiment, a user (e.g., a device developer and/or a device manufacturer) may recognize the corresponding precondition and/or the state of the device when the user's voice input is received through a user interface (e.g., a voice metadata editor) and may create and edit voice metadata configured to perform an action corresponding to a precondition to perform an action corresponding to a voice input as desired based on the recognized results. According to an embodiment, the voice metadata created or edited by the user may be stored in the voice metadata module (e.g., the voice metadata module 625 of FIG. 6) (e.g., voice metadata storage (e.g., the voice metadata storage 6253 of FIG. 6 or the voice metadata storage 1040 of FIG. 10). According to an embodiment, the voice metadata stored in the voice metadata module may be downloaded and executed by the intent handler module at the request of the intent handler module.

FIGS. 13E to 13G illustrate that voice metadata is written in a form of a graph including nodes. However, according to various embodiments, the voice metadata writing method is not limited thereto. For example, the voice metadata is not limited to the graph method. For example, the voice metadata may be written in various methods of processing and/or implementing information (e.g., user intent-related information to be included in the voice metadata) entered from a user through a user interface.

According to various embodiments, FIGS. 13A to 13G illustrate examples of writing voice metadata, but are not limited thereto. For example, a specific configuration and/or arrangement of a user interface may be changed.

According to an embodiment of the disclosure, an operating method of an electronic device (e.g., the electronic device 101 or the server 108 of FIG. 1, the intelligence server 300 and/or the service server 400 of FIG. 2, the electronic device 500 of FIG. 5, or the electronic device 620 of FIG. 6) may include receiving a voice input of a user from an external electronic device (e.g., the electronic device 101 of FIG. 1, the user terminal 201 of FIGS. 2 to 4, or the external electronic device 610 of FIG. 6), recognizing voice metadata associated with the voice input based on the voice input, determining, based on the voice metadata, whether there is a precondition to perform an action corresponding to the voice input, responsive to determining that the precondition is present, transmitting a first command for performing an action corresponding to the precondition, based on the voice metadata to a target device (e.g., the target device 640 of FIG. 6), and transmitting a second command for performing the action corresponding to the voice input to the target device.

According to an embodiment, the method may further include causing the target device to provide the external electronic device with a result of performing the action corresponding to the voice input.

According to an embodiment, the recognizing of the voice metadata may include recognizing a user intent and a target device, which will perform the action corresponding to the voice input, based on the voice input and recognizing the voice metadata based on the user intent and information associated with the target device.

According to an embodiment, the information associated with the target device may include at least one of a vendor identification (VID) of the target device, a type of the target device, or manufacturer information of the target device.

According to an embodiment, the method may further include transmitting the first command for performing the action corresponding to the precondition and the second command for performing the action corresponding to the voice input to the target device through the electronic device and a cloud server (e.g., the server 108 of FIG. 1, the cloud 630 of FIG. 6, or the cloud 930 of FIG. 9) connected to the target device.

According to an embodiment, the transmitting of the command for performing the action corresponding to the precondition to the target device may include responsive to determining that the precondition is present, identifying a state of the target device associated with the precondition and responsive to determining that the state of the target device does not satisfy the precondition, transmitting the first command for performing the action corresponding to the precondition based on the voice metadata to the target device.

According to an embodiment, the user intent may include at least one of voice capability information, voice action information, and parameter information, which are associated with the action corresponding to the voice input.

According to an embodiment, the voice metadata may be stored in advance in a memory of the electronic device with respect to the external electronic device connected to the electronic device.

According to an embodiment of the present disclosure, in a computer-readable recording medium storing instructions, the instructions may, when executed by an electronic device (e.g., the electronic device 101 or the server 108 of FIG. 1, the intelligence server 300 and/or the service server 400 of FIG. 2, the electronic device 500 of FIG. 5, or the electronic device 620 of FIG. 6), cause the electronic device to perform receiving a voice input of a user from an external electronic device (e.g., the electronic device 101 of FIG. 1, the user terminal 201 of FIGS. 2 to 4, or the external electronic device 610 of FIG. 6), recognizing voice metadata associated with the voice input based on the voice input, determining, based on the voice metadata, whether there is a precondition to perform an action corresponding to the voice input, responsive to determining that the precondition is present, transmitting a first command for performing an action corresponding to the precondition based on the voice metadata to a target device (e.g., the target device 640 of FIG. 6), and transmitting a second command for performing the action corresponding to the voice input to the target device.

According to an embodiment, the instructions may, when executed by an electronic device, cause the electronic device to perform causing the target device to provide the external electronic device with a result of performing the action corresponding to the voice input.

According to an embodiment, the recognizing of the voice metadata may include recognizing a user intent and a target device, which will perform the action corresponding to the voice input, based on the voice input of the user and recognizing the voice metadata based on the user intent and information associated with the target device.

According to an embodiment, the transmitting of the first command for performing the action corresponding to the precondition to the target device may include responsive to determining that the precondition is present, identifying a state of the target device associated with the precondition and responsive to determining that the state of the target device does not satisfy the precondition, transmitting the command for performing the action corresponding to the precondition based on the voice metadata to the target device.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

1. An electronic device comprising:
a communication circuit;
a memory; and
a processor operatively connected to the communication circuit and the memory,
wherein the memory stores instructions that, when executed, cause the processor to:
receive a voice input of a user from an external electronic device by using the communication circuit;
recognize voice metadata associated with the voice input based on the voice input;
determine, based on the voice metadata, whether a precondition to perform an action corresponding to the voice input is present;
responsive to determining that the precondition is present, transmit a first command for performing an action corresponding to the precondition based on the voice metadata to a target device by using the communication circuit; and
transmit a second command for performing the action corresponding to the voice input to the target device by using the communication circuit.

2. The electronic device of claim 1, wherein the instructions, when executed, cause the processor to:
cause the target device to provide the external electronic device with a result of performing the action corresponding to the voice input.

3. The electronic device of claim 1, wherein the instructions, when executed, cause the processor to:
recognize a user intent and the target device, which will perform the action corresponding to the voice input, based on the voice input of the user; and
recognize the voice metadata based on the user intent and information associated with the target device.

4. The electronic device of claim 3, wherein the information associated with the target device includes at least one of a vendor identification (VID) of the target device, a type of the target device, or a manufacturer information of the target device.

5. The electronic device of claim 1, wherein the instructions, when executed, cause the processor to:
transmit the first command for performing the action corresponding to the precondition and the second command for performing the action corresponding to the voice input to the target device through the electronic device and a cloud server connected to the target device.

6. The electronic device of claim 1, wherein the instructions, when executed, cause the processor to:
responsive to determining that the precondition is present, identify a state of the target device associated with the precondition; and
responsive to determining that the state of the target device does not satisfy the precondition, transmit the first command for performing the action corresponding to the precondition based on the voice metadata to the target device.

7. The electronic device of claim 3, wherein the user intent includes at least one of voice capability information, voice action information, and parameter information, which are associated with the action corresponding to the voice input.

8. The electronic device of claim 1, wherein the voice metadata is stored in advance in a memory of the external electronic device connected to the electronic device.

9. An operating method of an electronic device, the method comprising:
receiving a voice input of a user from an external electronic device;
recognizing voice metadata associated with the voice input based on the voice input;
determining, based on the voice metadata, whether a precondition to perform an action corresponding to the voice input is present;
responsive to determining that the precondition is present, transmitting a first command for performing an action corresponding to the precondition based on the voice metadata to a target device; and
transmitting a second command for performing the action corresponding to the voice input to the target device.

10. The method of claim 9, further comprising:
causing the target device to provide the external electronic device with a result of performing the action corresponding to the voice input.

11. The method of claim 9, wherein the recognizing of the voice metadata includes:
recognizing a user intent and the target device, which will perform the action corresponding to the voice input, based on the voice input; and
recognizing the voice metadata based on the user intent and information associated with the target device.

12. The method of claim 9, wherein the information associated with the target device includes at least one of a vendor identification (VID) of the target device, a type of the target device, or a manufacturer information of the target device.

13. The method of claim 9, further comprising:
transmitting the first command for performing the action corresponding to the precondition and the second command for performing the action corresponding to the voice input to the target device through the electronic device and a cloud server connected to the target device.

14. The method of claim 9, wherein the transmitting of the first command for performing the action corresponding to the precondition to the target device includes:
responsive to determining that the precondition is present, identifying a state of the target device associated with the precondition; and
responsive to determining that the state of the target device does not satisfy the precondition, transmitting the first command for performing the action corresponding to the precondition based on the voice metadata to the target device.

15. The method of claim 11, wherein the user intent includes at least one of voice capability information, voice action information, and parameter information, which are associated with the action corresponding to the voice input.

16. The method of claim 9, wherein the voice metadata is stored in advance in a memory of the electronic device with respect to the external electronic device connected to the electronic device.

17. A computer-readable recording medium storing instructions, the instructions, when executed by an electronic device, cause the electronic device to perform:
receiving a voice input of a user from an external electronic device;
recognizing voice metadata associated with the voice input based on the voice input;
determining, based on the voice metadata, whether there is a precondition to perform an action corresponding to the voice input;
responsive to determining that the precondition is present, transmitting a first command for performing an action corresponding to the precondition based on the voice metadata to a target device; and
transmitting a second command for performing the action corresponding to the voice input to the target device.

18. The computer-readable recording medium of claim 17, wherein the instructions, when executed by an electronic device, cause the electronic device to perform:
causing the target device to provide the external electronic device with a result of performing the action corresponding to the voice input.

19. The computer-readable recording medium of claim 17, wherein the recognizing of the voice metadata includes:
recognizing a user intent and the target device, which will perform the action corresponding to the voice input, based on the voice input of the user; and
recognizing the voice metadata based on the user intent and information associated with the target device.

20. The computer-readable recording medium of claim 17, wherein the transmitting of the first command for performing the action corresponding to the precondition includes:
responsive to determining that the precondition is present, identifying a state of the target device associated with the precondition; and
responsive to determining that the state of the target device does not satisfy the precondition, transmitting the first command for performing the action corresponding to the precondition based on the voice metadata to the target device.

21. An operating method of an electronic device, the method comprising:
recognizing voice metadata associated with a voice input of the user based on a voice input received from an external electronic device;
determining, based on the voice metadata and a state of a target device, whether a precondition to perform an action corresponding to the voice input is present;
responsive to determining that the precondition is present, transmitting a first command for performing an action corresponding to the precondition based on the voice metadata to the target device; and
transmitting a second command for performing the action corresponding to the voice input to the target device.
